(19) United States
(12) Patent Application Publication
(10) Pub. No.: US 2007/0147766 A1
(43) Pub. Date: Jun. 28, 2007

(54) Low loss silicon oxynitride optical waveguide, a method of its manufacture and an optical device

(76) Inventors: Kent Erik Mattsson, Virum (DK); Lars Pleth Nielsen, Allerod (DK)

Correspondence Address: JACOBSON HOLMAN PLLC, 400 SEVENTH STREET N.W., SUITE 600, WASHINGTON, DC, 20004, US

(21) Appl. No.: 10/579,244

(22) PCT Filed: Nov. 10, 2004
(86) PCT No.: PCT/EP04/52913

§ 371 Date: May 12, 2006

(30) Foreign Application Priority Data
Nov. 12, 2003 (DK) PA 2003 01686

(51) Int. Cl. G02B 6/00

(52) U.S. Cl. 385/142; 385/144

(57) ABSTRACT

The invention relates to an optical waveguide for guiding light in a predefined wavelength range, the optical waveguide comprising core and cladding regions for confining light, the core and/or cladding region or regions being formed on a substrate and comprising material of the stoichiometric composition SiₐOₓN_{y}X_{z}H. The invention further relates to a method of manufacturing an optical waveguide, an optical waveguide obtainable by the method and an optical device comprising such a waveguide. The object of the present invention is to provide an optical waveguide with low optical loss due to a reduced hydrogen bond-originated absorption. The problem is solved in that X is selected from the group of elements B, Al, P, S, As, Sb and combinations thereof, and the ratio y/z is larger than 1. This has the advantage that a low optical absorption in the waveguide may be achieved, possibly over a broad wavelength range. Further, a relatively low annealing temperature may be used yielding a relatively low induced strain whereby a low birefringence may be achieved. The optical waveguide may e.g. be manufactured by PECVD, which is ideal for the further processing of low loss waveguides. Waveguides according to the invention show superior transmission characterized with losses below 0.05 dB/cm between 900 nm and 1600 nm. In particular the absorption due to the second overtone of the Si:N—H vibration may be lowered to a value below the detection level. The invention may e.g. be used for the optical communications systems, in particular for branching components (e.g. splitters) and components for wavelength division multiplexing (WDM) systems, e.g. telecommunication systems, fibre-to-the-home, etc.

### TECHNICAL FIELD

This invention relates to the manufacture of high quality optical films.

The invention relates specifically to an optical waveguide for guiding light in a predefined wavelength range, the optical waveguide comprising core and cladding regions for confining light, the core and/or cladding region or regions being formed on a substrate, and the whole or a part of the core and/or cladding region or regions comprising material of the stoichiometric composition SiₐOₓN_{y}X_{z}Hᵥ.

The invention furthermore relates to: A method of manufacturing an optical waveguide for guiding light in a predefined wavelength range, the optical waveguide comprising core and cladding regions for confining light, to an optical waveguide obtainable by the method and to an optical device comprising an optical waveguide.

This invention can be applied to all types of optical devices based on index guiding waveguide layers as well as photonic band gap related waveguide technologies. The invention may e.g. be useful in applications such as optical communication systems, in particular for branching components (e.g. splitters) and components for wavelength division multiplexing (WDM) systems, e.g. telecommunication systems, fibre-to-the-home-systems, etc.

### BACKGROUND ART

It is well known that it is difficult to fabricate optically transparent silica based waveguides with sufficiently low losses over a broad range of wavelengths. The commercially mature planar glass on silicon waveguide technology is typically based on low-index contrast (e.g. less than 0.7%), the index difference between core and cladding being calculated as:
(Δn/<n>)·100%=100%·2·(n₁−n₂)/(n₁+n₂).

This more or less standard low-index technology platform ensures planar waveguide components with low propagation loss (<0.05 dB/cm) and low fiber-to-chip coupling losses (e.g. <0.3 dB/facet). The refractive index difference between the waveguide core and cladding is generally achieved by doping the silica core material with higher refractive index oxides such as germanium, phosphorous oxide, titanium oxide, etc., in order to raise the refractive index above that of the surrounding cladding.

Increasing the index above 0.7% will allow for smaller bending radii without increasing the bending loss, and hence, smaller devices may be fabricated (cf. e.g. “A Low-Loss, compact wide-FSR-AWG using Planar Lightwave Circuit Technology”, C. Doerr, FJ1 OFC 2003). This will allow for more devices per wafer, or alternatively create space for more complex components with higher functionalities. Higher index contrast will eventually also open up for devices which cannot be made at a lower index contrast such as planar devices utilising a photonic band gap (PBG) effect. Recent developments in the design and fabrication of visible PBG waveguide devices in Si₃N₄ type materials have been discussed extensively by M. D. B. Charlton, et al., J. of Materials Science: Materials in Electronics 10 (1999) p. 429-440 (and references herein).

As a promising production platform for higher index waveguides, an oxynitride (SiOₓN_{y}) type of material has been discussed extensively in the literature. It has been known for a long time, and shown by several groups, that a SiOₓN_{y} type material can be fabricated with a tuneable refractive index which can be varied between that of SiO₂ (1.455) and that of Si₃N₄ (2.02) by conventional deposition techniques (such as chemical vapour deposition (CVD), plasma enhanced CVD (PECVD), atmospheric pressure CVD (APCVD) or low pressure CVD (LPCVD) processes, cf. e.g. “Reduction of hydrogen induced losses in PECVD-SiOₓN_{y} optical waveguides in the near infrared”, H. Albers et al., in Proceedings of OFPW3.4, LEOS '95, IEEE Lasers and Electro-Optics Society 1995 Annual Meeting, 8th Annual Meeting. Although the high-end range of the refractive indices has been shown to have a high tendency for crack formation upon annealing to elevated temperatures, it has never the less been demonstrated that it is in principle possible to tune the refractive index over the entire range, i.e. to achieve index differences from 0% (SiO₂) to 32.5% (Si₃N₄).

However, from the literature it is also known that SiOₓN_{y} films will contain Si:N—H bonds giving rise to an absorption peak at a wavelength λ=1508 nm due to an overtone of the Si:N—H vibration located around 3300 cm⁻¹ (k=1/(nλ), where n is the order of the overtone, here n=2). Even though the N—H vibration is at 1508 nm the “tail” of this peak extends into the telecom band giving rise to absorption at 1550 nm which is in the middle of the telecom C-band (1530-1565 nm). Increasing the bandwidth to include the S-(1460-1530 nm) and the E- (1360-1460 nm) and the O-band (1260-1360 nm) the Si:N—H vibrations will be even more destroying when the aim is to fabricate low loss, high index contrast devices working over a broad wavelength range.

The intensity of the Si:N—H absorption peak can be lowered by annealing the as deposited SiOₓN_{y} film to elevated temperatures (cf. e.g. “Silicon Oxynitride Layers for Optical Waveguide Applications”, R. Germann et al., J. of Electrochemical Society, 147(6), p. 2237-2241 (2000) or “Passband flattened binary-tree structured add-drop multiplexers using SiON waveguide technology”, Ph. D Thesis by Chris Roeloffzen, Twente, 2002 (ISBN 90-365-1803-2)). Annealing temperatures as high as 1150° C. have been reported in the literature giving losses at the peak maxima of around 0.6 dB/cm. Unfortunately, it is not possible to completely remove the absorption peak by simple annealing, and furthermore, the annealing approach also has another drawback of increasing the stress in the film layer giving rise to a significant increase in the birefringence of the film (the degree of birefringence being defined by the difference between the refractive indices n_{TE} and n_{TM} of the transverse electric (TE) and transverse magnetic (TM) modes, respectively). This is clearly an unwanted side effect of extensive annealing.

A decrease in hydrogen-bond related loss upon annealing of SiON-type material is also discussed in US patent applications US-2002-0182342, US-2002-0194876 and US-2002-0178760, among others.

The variety of different CVD processes discussed in the literature can be grouped into two different categories, i.e. a type A process using NH₃ as one of the gasses from which the film layer is formed and a type B process where the films are nucleated from a gas composition which is not containing NH₃. We have mapped out various different PECVD combinations of type A and B processes. In accord with the findings in the literature, we find that there is a fairly high loss around 1508 nm due to the presence of Si:N—H bonds in films based on both types of processes (cf. FIG. 4). This is also the case after annealing up to 16 hours at 1150° C. However, the loss due to vibrating N—H bonds is slightly lower for films formed on the basis of a type B recipe as compared to films formed by a type A recipe. Intuitively this is also excepted, since a film based on a type A recipe is expected to contain a higher density of N—H bonds since N—H bonds are directly introduced into the film layer through fragments of the NH₃ molecule, e.g. NHₓ, x=1, 2. In accord with the literature we also saw that the absorption loss could be decreased by increasing the annealing temperature and/or the annealing time.

Unfortunately the improved losses obtained by annealing are still not low enough for low loss broad banded telecom related components.

One way to reduce the hydrogen concentration in silicon oxynitride material of the stoichiometric form SiₐOₓN_{y}A_{z}MᵥHᵤ is according to WO-99/44937 to incorporate penta- or hexa-valent elements (A) from Group 15, 16 of the periodic system and/or mono- or di-valent metals (M) from groups 1, 2, 11 or 12 interstitially in the glass matrix. This is expected to reduce the hydrogen affinity of the nitrogen atoms and therefore to reduce the optical losses due to N—H-absorption. Preferred embodiments are elements of the stoichiometric form SiₐOₓN_{y}A_{z}MᵥHᵤ wherein z≧y and/or v≧y, i.e. the concentration of Nitrogen is less than or equal to the concentration of A- (e.g. P, As, etc.) or M-elements (e.g. Li, Be, Cu, Zn. etc.).

In EP-1295963 A2, EP-1273677 A2, and EP-1302792 A2 the optimization of process parameters such as flow rates, pressures, temperatures, gases, etc. in various steps of a PECVD process for deposition of silica films on a wafer and subsequent heat treatment are described, the optimization being performed with a view to reduce the optical absorption due to Si:N—H and Si:O—H oscillators.

No characterisation of propagation loss measurements on a finished planar waveguide has been performed in WO-99/44937. In EP-1295963 and EP-1273677 it is suggested to optimise the thermal treatment which allows the optical properties to be maintained while modifying the mechanical stress of the core. There is, however, no clear evidence for a correlation between optical loss and mechanical stress of the core layer, since the stress effect of the upper cladding layer is not considered in the spectroscopy characterisation of the core layer.

### DISCLOSURE OF INVENTION

The object of the present invention is to provide an optical waveguide with low optical loss due to a reduced hydrogen bond-originated absorption. It is a further object to provide an optical waveguide with low optical loss due to absorption in a wavelength range used for optical transmission. In an embodiment of the invention, it is a further object to lower or remove absorption peaks due to hydrogen bonds in an optical waveguide. In an embodiment of the invention, it is a further object to lower or remove absorption peaks due to N—H bonds in an optical waveguide. In an embodiment of the invention, it is a further object to lower or remove absorption peaks due to O—H bonds in an optical waveguide. In an embodiment of the invention, it is a further object to lower or remove absorption peaks due to Si—H bonds in an optical waveguide.

The objects of the invention are achieved by the invention described in the accompanying claims and as described in the following.

An optical waveguide for guiding light in a predefined wavelength range, the optical waveguide comprising core and cladding regions for confining light, the core and/or cladding region or regions being formed on a substrate, and the whole or a part of the core and/or cladding region or regions comprising material of the stoichiometric composition SiₐOₓN_{y}X_{z}Hᵥ is provided by the invention wherein X is selected from the group of elements B, Al, P, S, As, Sb and combinations thereof, and the ratio y/z is larger than 1, such as larger than 1.2, such as larger than 1.5, such as larger than 1.8, such as larger than 2.0, such as larger than 2.5, such as larger than 3.0, such as larger than 3.5, such as larger than 4.0, such as larger than 4.5, such as larger than 5.0, such as larger than 5.5, such as larger than 6.0, such as larger than 7.0, such as larger than 8.0.

An advantage of the invention is that a low optical absorption in the waveguide may be achieved. In an embodiment of the invention, a low absorption in the waveguide may be obtained over a broad wavelength range, e.g. in the range 1530-1565 nm. Further, in an embodiment of the invention, a relatively low annealing temperature may additionally be used yielding a relatively low induced strain whereby a low birefringence may be achieved.

The present invention demonstrates that is possible to make an optical waveguide with low optical absorption properties in the S-, C-, L- and O-bands. In particular, it is possible to lower the density of Si:N—H bonds to provide an absorption below 0.1 dB/cm (such as below 0.05 dB/cm) in a SiₐOₓN_{y}X_{z}Hᵥ type material where y>z, i.e. the concentration of X (e.g. P) is less than the concentration of N.

In an embodiment of the invention, it is further possible to tune the inherent stresses by adjusting the y/z ratio or by adding a third element or a combination of elements. In an embodiment the amount of Phosphorus is used to optimize (e.g. to minimize) the inherent stresses of the optical waveguide.

In the present context, the term “waveguide” is taken to mean any elongate guide structure which permits the propagation of a wave throughout its length despite diffractive effects, and possibly curvature of the guide structure. “An optical waveguide” based on total internal reflection is defined by an extended region of increased index of refraction relative to the surrounding medium. “An optical waveguide” based on a photonic band gap is defined by an extended core region surrounded by a photonic band gap material comprising a periodic pattern of holes or a periodic pattern of high index material. The strength of the guiding, or the confinement, of the wave depends on the wavelength, the index difference and the guide width. Stronger confinement leads generally to narrower modes. An optical waveguide may support multiple optical modes or only a single mode, depending on the strength of the confinement. In general, an optical mode is distinguished by its electromagnetic field geometry in two dimensions, by its polarization state, and by its wavelength. The polarization state of a wave guided in a birefringent material or an asymmetric waveguide is typically linearly polarized. However, the general polarization state may contain a component of nonparallel polarization as well as elliptical and unpolarized components, particularly if the wave has a large bandwidth. If the index of refraction difference is small enough (e.g. Δn=n₁−n₂=0.036) and the dimension of the guide is narrow enough (e.g. width W=3 μm), the waveguide will only confine a single transverse mode (the lowest order mode) over a range of wavelengths. If the waveguide is implemented on the surface of a substrate so that there is an asymmetry in the index of refraction above and below the waveguide, there is a cutoff value in index difference or waveguide width below which no mode is confined. A waveguide may be implemented in a substrate (e.g. by diffusion into the substrate), on a substrate (e.g. by applying a coating and etching away the surrounding regions, or by applying a coating and etching away all but a strip to define the waveguide), inside a substrate (e.g. by contacting or bonding several processed substrate layers together). The optical mode which propagates in the waveguide has a transverse dimension which is related to all of the confinement parameters, not just the waveguide width.

The width and height of a waveguide element is in the present context taken in a transversal cross section of the waveguide core (i.e. in a cross section perpendicular to the intended direction of light guidance of said waveguide core elements at the location of a width measurement), the width being a dimension of the core region of the waveguide element in question in a direction parallel to a reference plane defined by the opposing, substantially planar, surfaces of the substrate (x-direction in FIG. 6), the height being a dimension of the core region of the waveguide element in question in a direction perpendicular to the reference plane (in a direction of growth, y-direction in FIG. 6).

The term “the stoichiometric composition’ of a material” reflects the relative number of units of the elements in question present in the material, e.g. Si_{0.97}O_{1.91}N_{0.09}P_{0.03} defining a material wherein (on average over a given volume of the material) for each 97 silicon atoms, 191 oxygen atoms, 9 nitrogen atoms and 3 phosphorus atoms are present. The suffixes or numbers a, x, y, z, v in the stoichiometric composition SiₐOₓN_{y}X_{z}Hᵥ represent the molar concentrations of the constituent elements calculated relative to the sum a+x+y+z+v, e.g. the relative concentration c(N) of the element nitrogen in the composition SiₐOₓN_{y}X_{z}Hᵥ equals y/(a+x+y+z+v). In the present context, the atomic concentration of an element Q (e.g. H) measured in atomic % (at. %) is taken to mean c(Q)·100 (i.e. for hydrogen c(H)·100=v·100/(a+x+y+z+v) in a SiₐOₓN_{y}X_{z}Hᵥ material).

The volume—termed a ‘given volume’ above—over which the composition is averaged—is preferably the total volume of the sample or layer having a given intended stoichiometric composition, e.g. the volume of the core. Alternatively, the ‘given volume’ may be a representative part of the total volume, i.e. a macroscopic part of the sample, such as more than 1% of the total volume of the part or layer in question, i.e. statistically large enough to allow a meaningful average value. Alternatively, the ‘given volume’ may be a volume that is at least 5 times the volume expected to comprise one unit of the stoichiometric composition in question, such as at least 100 times, such as at least 1000 times. Alternatively, the ‘given volume’ may be defined by a dimension comparable to the wavelength λ of the propagating wave in question, such as 2 times λ, such as 10 times λ.

The atomic density (atoms/unit volume, e.g. atoms/cm³) of the different elements in a given sample may e.g. be determined by Secondary Ion Mass Spectrometry (SIMS) measurement or by an energy-dispersive X-ray analysis (EDX) measurement. The basic principles of both techniques are discussed extensively in various textbooks, see e.g. “Fundamentals of surface and thin films analysis”, L. C. Feldman, J. W. Mayer, ISBN 0-441-00989-2, wherein—for example—quantitative analysis down to an accuracy of about 1% by EDX is discussed. EDX is characterized by being a surface sensitive tool with electron penetration depths between 5 and 100 Å, depending on the energy of the incoming electron.

A connection between atomic concentration and relative molar concentration may be estimated by assuming or measuring a certain mass density ρ(SiONXH) of the resulting material (H may optionally be neglected due to its small contribution to the mass density). The atomic density Nₐₜ for a given element Q (Q=Si, O, N, X, H) is given by the formula
Nₐₜ(Q)=c(Q)·ρ(SiONXH)·Nₐ/Mₜₒₜ
where c(Q), as mentioned above, is the relative concentration of the element Q in the composition SiₐOₓN_{y}X_{z}Hᵥ, Nₐ is Avogadro's number (the number of atoms or molecules in a mole) and Mₜₒₜ=a·M_{Si}+x·Mₒ+y·M_{N}+z·M_{X}+v·M_{H} is the mole mass (unit mass/mole, e.g. g/mole) of the SiₐOₓN_{y}X_{z}Hᵥ-material, where M_{Q} is the atomic mass of element Q (e.g. M_{Si}=28.086 g/mole).

In an embodiment, the material further comprises Ge. In other words, Ge may be present in combination with one or more of the elements X=B, Al, P, S, As, Sb. This has the additional advantage of providing the possibility to fine tune the refractive index and to tailor the photosensitivity of the material.

In an embodiment of the invention, the optical waveguide comprises a cladding region surrounding the core region. In an embodiment of the invention, the cladding and the core region comprises material of the stoichiometric composition SiₐOₓN_{y}X_{z}Hᵥ and wherein X is selected from the group of elements B, Al, P, S, As, Sb and combinations thereof (and/or in combination with Ge), and the ratio y/z is larger than 1. The index difference between core and cladding may e.g. be provided by changing the y/x ratio (i.e. changing the [N]/[O]-concentrations, e.g. by changing the y/x ratio of the feed gas in a CVD-process). In an embodiment of the invention, the core and/or cladding region or regions are constituted essentially of material of the stoichiometric composition SiₐOₓN_{y}X_{z}Hᵥ. The term ‘constituted essentially of material . . . ’ is taken to refer to the elements of significance to the merits of the invention.

In an embodiment of the invention the, core region comprises material of the stoichiometric composition SiₐOₓN_{y}X_{z}Hᵥ and wherein X is selected from the group of elements B, Al, P, S, As, Sb and combinations thereof (and/or in combination with Ge). In this embodiment, the cladding region or regions may comprise any type of material having an appropriate refractive index, e.g. a PBSG type glass or a PBG region.

In an embodiment of the invention the, waveguide comprises a core region and two or more surrounding cladding regions (e.g. two ‘concentric’ cladding regions wherein at least one of the cladding regions comprises material of the stoichiometric composition SiₐOₓN_{y}X_{z}Hᵥ and wherein X is selected from the group of elements B, Al, P, S, As, Sb and combinations thereof (and/or in combination with Ge). In this embodiment, the core region may comprise any type of material having an appropriate refractive index, e.g. a PBSG type glass or a PBG type glass or a Ge doped silica glass. In this embodiment, a further cladding region or regions may comprise any type of material having an appropriate refractive index, e.g. a PBSG type glass or a PBG region or SiO₂.

In an embodiment of the invention, the ratio y/z is in the range 1.0 to 100, such as 1.0 to 20, such as 1.0 to 10, such as 1.5 to 8.0, such as 2.0 to 4.0, such as 2.5 to 3.5.

In an embodiment of the invention, the ratio y/z is essentially equal to 3.

In an embodiment of the invention, the ratio y/z is essentially equal to 7.

The term ‘essentially equal to’ is in the present context taken to mean being within 10% of the value in question, such as within 5%, such as within 1%.

In an embodiment of the invention, the number ‘a’ defining the relative concentration of the element Si is in the range 0.1 to 3.5, such as in the range 0.5 to 3.5 such as in the range 0.9 to 1.1 (e.g. SiO₂-like) or in the range 2.9 to 3.1 (e.g. Si₃N₄-like).

In an embodiment of the invention, the number ‘x’ defining the relative concentration of the element O is in the range 0 to 2.5, such as in the range 1.9 to 2.1 (e.g. SiO₂-like) or in the range 0 to 0.1 (e.g. Si₃N₄-like).

In an embodiment of the invention, the number ‘y’ defining the relative concentration of the element N is in the range 0 to 4.5, such as in the range 3.9 to 4.1 (e.g. Si₃N₄-like) or in the range 0 to 0.5, such as in the range 0.02 to 0.3, such as in the range 0.03 to 0.2, such as in the range 0.04 to 0.10.

In an embodiment of the invention, the number ‘z’ defining the relative concentration of the element X selected from the group comprising B, Al, P, S, As, Sb and combinations thereof is in the range 0 to 0.3, such as in the range 0 to 0.2, such as in the range 0.005 to 0.2, such as in the range 0.01 to 0.10.

In an embodiment of the invention, the number ‘v’ defining the relative concentration of the element H is defined by 0≦v<0.05.

In an embodiment of the invention, ‘a’ is in the range 0.8 to 1.2 and ‘x’ is in the range 1.8 to 2.2 and ‘y’ is in the range 0.01 to 0.5 and ‘z’ is in the range 0.005 to 0.2. This illustrates the situation of a SiO₂-based SiONX-composition with comparatively small relative amounts of N and X-elements.

In an embodiment of the invention, ‘a’ is in the range 2.8 to 3.2 and ‘x’ is in the range 0.01 to 0.5 and ‘y’ is in the range 3.8 to 4.2 and ‘z’ is in the range 0.005 to 0.2. This illustrates the situation of a Si₃N₄-based SiONX-composition with minor relative portions of O and X-elements.

In an embodiment of the invention, the number ‘a’ defining the relative concentration of the element Si is in the range 0.9 to 1.1, the number ‘x’ defining the relative concentration of the element O is in the range 1.9 to 2.1, the number ‘y’ defining the relative concentration of the element N is in the range 0.015 to 0.12, and the number ‘z’ defining the relative concentration of the element X is in the range 0.005 to 0.04.

In an embodiment of the invention, the waveguide core and/or cladding layers comprise material of the stoichiometric composition Si_{(1-z)}O_{(2-y)}N_{y}X_{z} wherein X is an element from the group comprising B, Al, P, S, As, Sb or a combination thereof.

In an embodiment of the invention, the waveguide core and/or cladding layers consists essentially of material of the stoichiometric composition Si_{(1-z)}O_{(2-y)}N_{y}X_{z} wherein X is an element from the group comprising B, Al, P, S, As, Sb or a combination thereof.

In an embodiment of the invention, the waveguide core and/or cladding layers comprise material of the stoichiometric composition Si_{(1-z)}O_{(2-y)}N_{y}P_{z}. In an embodiment of the invention, 0≦y<0.2 and 0<z≦0.1. In embodiments of the invention, the atomic density of silicon Nₐₜ(Si) in the range 4.5·10²¹<Nₐₜ(Si)<1.3·10²², such as in the range 5.1.·10²¹<Nₐₜ(Si)<9.1·10²¹, the atomic density of oxygen Nₐₜ(O) is in the range 9.0·10²¹Nₐₜ(O)<2.7·10²², such as in the range 1.0·10²²<Nₐₜ(O)<1.8·10²², the atomic density of nitrogen Nₐₜ(N) is in the range 0<Nₐₜ(N)<2.7·10²¹, such as in the range 0<Nₐₜ(N)<1.8·10²¹, and the atomic density of phosphorus Nₐₜ(P) is in the range 0<Nₐₜ(P)<1.3·10²¹, such as in the range 0<Nₐₜ(P)<9.0·10²⁰.

In an embodiment of the invention, the atomic density of at least one of the elements Si, O, N, P in Si_{(1-z)}O_{(2-y)}N_{y}P_{z} is determined by SIMS.

In an embodiment of the invention, the atomic density of at least one of the elements Si, O, N, P in Si_{(1-z)}O_{(2-y)}N_{y}P_{z} is determined by EDX.

In an embodiment of the invention, X comprises more than one element, such as two or more, such as m in total, each having a relative concentration compared to the total concentration z of X termed z₁ for X(1) and z₂ for X(2), etc., and zₘ for X(m). The term “the element or elements X of the material SiₐOₓN_{y}X_{z}Hᵥ comprises at least q₁% of the element X(1)” is in the present context taken to mean that q₁/100=z₁/z, where z=SUM(zᵢ), i=1, 2, . . . , m, where SUM(zᵢ) denotes the algebraic sum of the elements zᵢ. The relative concentration of the element X(i) in the material SiₐOₓN_{y}X_{z}Hᵥ, on the other hand, is zᵢ/(a+x+y+z+v).

In an embodiment of the invention, the element or elements X or the material SiₐOₓN_{y}X_{z}Hᵥ comprises at least 50% phosphorus such as at least 75% phosphorus such as at least 90% phosphorus, such as 100% phosphorus.

In an embodiment of the invention, the element or elements X or the material SiₐOₓN_{y}X_{z}Hᵥ comprises at least two elements X(1), X(2), . . . , X(n) where n≦7, selected from the group comprising B, Al, P, S, Ge, As, Sb of relative concentrations z₁, z₂, . . . , zₙ, respectively, where z=z₁+z₂+z₃+ . . . +zₙ and wherein z₁/z is larger than 0.50 such as larger than 0.75 such as larger than 0.90.

In general, the addition of P, Ge and N to silica glass base increases the refractive index, whereas the addition of B decreases the refractive index of the resulting waveguide material. In general, the addition of B and P increases the flow properties of a resulting silica glass. Interestingly, we have in connection with the present invention observed that the addition of P to SiON lowers the refractive index, suggesting that P might substitute N.

Recently it has been suggested (US2003/0021578) that the addition of Ge to a BPSG material allows for a decrease in P while retaining the same refractive index. As a consequence of the lower P-concentration, a smaller density of BPO₄ is formed during subsequent annealing, allowing for an improved reflow mechanism enabling the fabrication of high-aspect ratio structures without keyhole formation (i.e. without voids or inclusions in the cladding material). Similarly, an improved reflow mechanism enabling the fabrication of high-aspect ratio structures without keyhole formation might be expected for SiₐOₓN_{y}X_{z}Hᵥ with X(1)=P, X(2)=Ge and X(3)=B.

In an embodiment of the invention, n=2 and X(1) is P and X(2) is B. In an embodiment of the invention, n=2 and X(1) is P and X(2) is Ge. This has the advantage that the relative concentrations of P and B or Ge may be used to fine tune the resulting refractive index.

In an embodiment of the invention, n=3 and X(1) is P, X(2) is B and X(3) is Ge. This has the advantage that the relative concentrations of P, B and Ge may be used to fine tune the resulting refractive index.

In an embodiment of the invention, the optical absorption peak at λ=1508 nm due to Si:N—H bonds is smaller than 0.1 dB/cm, such as smaller than 0.05 dB/cm, such as smaller than 0.01 dB/cm, as measured e.g. by a planar version of a conventional cut-back-method.

The concentration of H is preferably so small that the optical absorption peak due to Si:N—H bonds is smaller than 0.1 dB/cm at λ=1508 nm, such as smaller than 0.05 dB/cm, such as smaller than 0.01 dB/cm. In an embodiment of the invention, the concentration of H is smaller than 10000 ppm (i.e. v/(a+x+y+z+v)<10⁻²), such as smaller than 1000 ppm, such as smaller than 100 ppm, such as smaller than 10 ppm. In an embodiment of the invention, the relative concentration of H is much smaller than the relative concentration of N, i.e. e.g. v<10⁻²y, such as v<10⁻³y, such as v<10⁻⁴y. In an embodiment of the invention, the relative concentration of H is much smaller than the relative concentration of X, i.e. e.g. v<10⁻²z, such as v<10⁻³z, such as v<10⁻⁴z, where X is an element selected from the group comprising B, Al, P, S, As, Sb and combinations thereof. In an embodiment of the invention, the atomic concentration of hydrogen is less than 25 at. %, such as less than 15 at. %, such as less than 5 at. %.

In an embodiment of the invention, the concentration of H is larger than the concentration of N or X or the concentration of N plus X (i.e. v>y, or v>z or v>y+z). However, in this case a part of the hydrogen atoms may not contribute to the optical absorption around 1508 nm and/or may not be bound in the material in an N—H type bond. In an embodiment of the invention, the concentration of hydrogen atoms in the material SiₐOₓN_{y}X_{z}Hᵥ is in the range 5 to 25 at. %, such as in the range 10 at. % to 20 at. %.

The hydrogen concentration of a sample may e.g. be determined by hydrogen nuclear reaction analysis (cf. e.g. “Fundamentals of surface and thin films analysis”, L. C. Feldman, J. W. Mayer, ISBN 0-444-00989-2).

It should be noted that a small percentage of nitrogen impurity will mostly be present in CVD deposited glass when nitrogen is used as carrier gas or for example as part of the oxygen containing reaction gasses (i.e. N₂O or NH₃). The percentages of the nitrogen impurity in such deposited glasses may be low and are often not measured or reported, partly because of the difficulty of ascertaining the nitrogen content with a reasonable accuracy. The analytical detection problem represents one reason why the unusual properties and advantages of chemically bound nitrogen in glasses are neither fully understood nor appreciated in the industry.

In an embodiment of the invention, the core and/or cladding region comprises material having a refractive index in the range 1.45-2.02, such as in the range 1.45 to 1.60, such as in the range 1.48 to 1.56 at a wavelength of 1550 nm. This may e.g. be achieved by addition of minor amounts of dopant ions such as Ge or Al. This has the advantage of allowing the manufacture of a relatively high index-waveguide while avoiding the N—H-absorption peak.

The term “the refractive index” of a region or volume represented by a particular cross sectional area of the waveguide is in the present context taken to mean the geometrical refractive index. If the region in question is constituted by one homogeneous material with a specific refractive index, the geometric refractive index is the normal refractive index for a homogeneous material. If the region in question is constituted by several smaller areas each of a homogeneous material, the geometric refractive index is the geometrically weighted average of the normal refractive indices of these smaller areas, i.e. the sum of the products of refractive index no and ratio Aᵢ/A of the partial area Aᵢ in question to the area A of the whole region being considered (i.e. SUM(nᵢ·(Aᵢ/A)), i=1, 2, . . . , m, where m is the number of smaller (or partial) areas constituting the region being considered).

In some cases the effective refractive index n_{eff} is conveniently used to characterize properties of an optical waveguide. Instead of considering the true waveguide structure with core and cladding the light propagation may be described as a plane wave propagating in a homogeneous medium having a refractive index n_{eff}, the so-called effective refractive index. This effective index is rooted in eigenvalue equations originating from Maxwell's equations.

The effective refractive index of a bound mode is greater than the cladding refractive index, and lower than the core refractive index. The effective index is furthermore a function of the waveguide core cross-sectional geometry, see e.g. H. Nishihara et al., “Optical Integrated Circuits”, McGraw-Hill (1989).

An optical waveguide according to the invention may be used for guiding light of any wavelength. In an embodiment of the invention, the optical waveguide is adapted to guide light in a wavelength range located in the range of 250 nm to 3.6 μm, such as in the range of 850 nm to 1800 nm. In an embodiment of the invention, the optical waveguide is adapted to guide light comprising wavelengths in the range of 1260 nm to 1660 nm, such as in the range 1530-1565 nm, or in the range 1460-1530 nm, or in the range 1360-1460 nm, or in the range 1260-1360 nm.

In an embodiment of the invention, the waveguide core and/or cladding further comprises one or more of the rare earth (RE) elements (i.e. the elements Ce, Pr, Nd, Pm, Sm, Eu, Gd, Tb, Dy, Ho, Er, Tm, Yb, Lu). In an embodiment of the invention, one or more of the RE elements are present in concentrations in the range 50 to 5000 ppm (mole/mole) i.e. in a material of the stoichiometric composition SiₐOₓN_{y}X_{z}Hᵥ(RE)_{q}, 50·10⁻⁶<q/(a+x+y+z+v+q)<5000·¹⁰⁻⁶. This has the advantage of enabling the formation of an active waveguide (for an amplifier or laser type functionality) in combination with the low absorption loss features.

In an embodiment of the invention, the core and/or cladding region or regions additionally comprise Ge in sufficient amounts to minimise internal stress due to thermal expansion or contraction of the waveguide. This has the advantage of enabling a reduce birefringence of the core and/or cladding layers In an embodiment of the invention, the material(s) of the core and/or cladding region or regions comprise less than 5 at. % Ge.

In an embodiment of the invention, the thermal expansion of one or more of the layers constituting the core and cladding regions of the waveguide is/are adapted to the thermal expansion of the substrate by adding one or more TE-dopant elements to said one or more layers of the waveguide. ‘TE-dopant’ is used as an abbreviation for ‘Thermal Expansion influencing dopants’.

In an embodiment of the invention, the TE-dopant element or elements is/are selected from the group of elements comprising Al, B, F, Ge, P, Ti, or combinations thereof.

In an embodiment of the invention, the TE-dopant element or elements are present in the core/and or cladding region or regions in molar concentrations in the range 0 to 5%, i.e. taken relative to the sum of the molar concentrations of Si, O, N, X, H, (and possibly RE-dopants) and TE-dopants.

In an embodiment of the invention, the TE-dopant element or elements are present in the core/and or cladding region or regions in amounts sufficient to provide a coefficient of thermal expansion between 1·10⁻⁷ ° C.⁻¹ and 15·10⁻⁷ ° C.⁻¹.

In an embodiment, the waveguide comprises Phosphorus in the core and/or in the cladding region(s).

In an embodiment, the optical waveguide comprises a buffer material constituting a barrier between the core and cladding regions and fully or partially surrounding the core region. In an embodiment, a barrier layer is only applied on top of the core region, thereby partially surrounding the core region. In an embodiment, a barrier layer is applied on top as well as below the core region, thereby fully surrounding the core region. An advantage of inserting the buffer layer or layers is that the tendency to formation of crystallites may be lowered or eliminated, whereby the out-diffusion of Phosphorus from the core region may be lowered or eliminated.

In an embodiment, the buffer material is selected from the group SiO₂, SiₓN_{y}, (i.e. SiₓN_{y} may e.g. be Si₃N₄), PECVD BPSG with alternative B/P doping levels and combinations thereof.

In an embodiment of the invention, the optical waveguide takes the form of a planar waveguide formed on a substrate. In an embodiment of the invention, the substrate is silicon. This has the advantage of facilitating large scale production. In an embodiment of the invention, the substrate is quartz. This has the advantage of inherently a lower cladding layer, and furthermore, induced stress from the substrate (e.g. silicon) is avoided.

In an embodiment of the invention, the waveguide is part of a photonic crystal structure, allowing the propagation of electromagnetic energy in a certain wavelength range to be controlled by the introduction of periodic structural features providing a photonic band gap (PBG).

In an embodiment of the invention, the optical waveguide is manufacture by chemical vapour deposition (CVD), such as plasma enhanced CVD (PECVD) or Atmospheric Pressure CVD (APCVD). This has the advantage of providing an industrially proven manufacturing technology which is reliable and readily scalable for large volumes.

Alternatively the waveguides may be manufactured by other techniques such as flame hydrolysis deposition or techniques for spinning materials on glass.

A method of manufacturing an optical waveguide for guiding light in a predefined wavelength range, the optical waveguide comprising core and cladding regions for confining light is furthermore provided by the present invention, the method comprising the steps of

A) providing a substrate,

B) forming a lower cladding layer on the substrate,

C) forming a core region of said optical waveguide on the lower cladding layer,

D) forming an upper cladding layer to cover the core region and the lower cladding layer;

wherein the whole or a part of said waveguide core and/or cladding region or regions comprise material of the stoichiometric composition SiₐOₓN_{y}X_{z}Hᵥ and X is selected from the group of elements B, Al, P, S, As, Sb and combinations thereof, and wherein y>z, such as larger than 1.2, such as larger than 1.5, such as larger than 1.8, such as larger than 2.0, such as larger than 2.5, such as larger than 3.0, such as larger than 3.5, such as larger than 4.0, such as larger than 4.5, such as larger than 5.0, such as larger than 5.5, such as larger than 6.0, such as larger than 7.0, such as larger than 8.0.

The method is easily integrated into proven state of the art manufacturing technologies of optical waveguides and integrated optical components having the advantages of corresponding (above mentioned) optical waveguides is provided.

In an embodiment of the invention, 0.5<a<3.5, 0<x<2.5, 0<y<4.5, 0<z<0.2.

In an embodiment of the invention, 0.5<a<3.5, 0<x<2.5, 0<y<4.5, 0<z<0.2 and 0≦v<0.05.

In an embodiment of the invention, v≧0.05. In an embodiment of the invention, v is larger than y or z or y+z. In an embodiment of the invention, the atomic concentration of hydrogen in the material SiₐOₓN_{y}X_{z}Hᵥ is less than 25 at. %, such as less than 15 at. %, such as less than 5 at. % or in the range 5 to 25 at. %, such as in the range 10 at. % to 20 at. %.

In an embodiment of the invention, 0.5<a<3.5, 0<x<2.5, 0<y<4.5, 0<z<0.2.

In an embodiment of the invention, 0.8<a<1.2, 1.8<x<2.2, 0.01<y<0.5, 0.005<z<0.2.

In an embodiment of the invention, 0.9<a<1.1, 1.9<x<2.1, 0.015<y<0.12, 0.005<z<0.04.

In an embodiment of the invention, 2.8<a<3.2, 0.01<x<0.5, 3.8<y<4.2, 0.005<z<0.2.

In an embodiment, the material further comprises Ge. In other words, Ge may be present in combination with one or more of the elements X=B, Al, P, S, As, Sb. This has the additional advantage of providing the possibility to fine tune the refractive index and to tailor the photosensitivity of the material.

In an embodiment of the invention, step C) comprises the sub-steps

C1) forming a core layer on the lower cladding layer,

C2) providing a core mask comprising a core region pattern corresponding to the layout of the core region of said optical waveguide, and

C3) forming core regions using the core mask, a photolithographic and an etching process. This has the advantage of availing the use of industry standard manufacturing processes, well-known from the manufacture of integrated semiconductor as well as optical circuits.

In an embodiment, a sub-step

C4) of forming a barrier layer on top of said core region pattern, and optionally on top of the lower cladding layer not covered by the core region pattern;

is inserted before step D). An advantage of inserting the buffer layer or layers is that the tendency to formation of crystallites may be lowered or eliminated, whereby the out-diffusion of Phosphorus from the core region may be lowered or eliminated.

In an embodiment, a sub-step C0) of forming a barrier layer on top of said lower cladding layer is inserted before step C1). This has the advantage of facilitating the formation of a barrier layer surrounding core region of the waveguide.

In an embodiment, a sub-step of annealing is inserted after said barrier forming step or steps C0), C4). This has the advantage of allowing reflow of the barrier layer before applying other layers, e.g. an upper cladding layer.

In an embodiment of the invention, the substrate is a silicon or quartz substrate.

In an embodiment of the invention, the optical waveguide is manufacture by chemical vapour deposition (CVD), such as plasma enhanced CVD (PECVD) or Atmospheric Pressure CVD (APCVD). This has the advantage of providing an industrially proven manufacturing technology which is reliable and readily scalable for large volumes.

In an embodiment of the invention, a standard cluster tool CVD process chamber type PECVD-apparatus from Surface Technology Systems is used for the formation of layers on the substrate.

In an embodiment of the invention,

the N₂ flow rate: is in the range 0-2000 sccm,

the N₂O flow rate is in the range 100-400 sccm,

the NH₃ flow rate is in the range 0-300 sccm,

the SiH₄ flow rate is in the range 0-30 sccm,

the 5% PH₃ in N₂ flow rate is in the range 0-50 sccm,

the power is in the range between 0 and 1200 W,

the pressure is in the range 50-500 mTorr,

the temperature is in the range 200-400° C.,

the frequency is around 380 kHz or around 13.56 MHz,

The unit sccm is short for Standard Cubic Centimeters per Minute being defined as a cubic centimetre at standard pressure and temperature (i.e. atmospheric pressure and 0° C.).

In an embodiment, the X=P and in i) the PH₃ flow is provided by PH₃ diluted in N₂ or another carrier gas.

In an embodiment, in i) the PH₃ flow is provided by 5% PH₃ in N₂ with a flow rate of 0 to 50 sccm such as 2 to 20 sccm.

In an embodiment, X comprises P and in i) the PH₃ flow is provided by PH₃ diluted in N₂ or another carrier gas and the PH₃ flow value is used as a stress optimization parameter for the core region.

In an embodiment, processing parameters of the PECVD process essentially have the following values:

a) SiH₄ flow rate 20 sccm;

b) the N₂O flow rate 100-400 sccm;

c) the N₂ flow rate 2000 sccm;

d) the NH₃ flow rate is 100 sccm;

e) the power is 700 W;

f) the pressure is 250 mTorr;

g) the temperature 350° C.;

h) the frequency is 380 kHz;

i) 5% PH₃ in N₂ flow rate 10 sccm.

In an embodiment, in step i) the flow gas is selected among the group of gases SiH₄, SiF₄, SiCl₄, SiF₄, Si₂H₆, SiH₂Cl₂, SiCl₂F₂, SiH₂F₂, N₂O, NO, N₂, NO₂, O₂, H₂O, H₂O₂, CO, CO₂, N₂O, NO, N₂, NO₂, NH₃, N₂, B₂H₆, AlH₃, PH₃, H₂S, SO, SO₂, GeH₄, AsH₃, or combinations thereof.

An optical waveguide obtainable by a method of manufacturing as described above is moreover provided by the present invention. Such a waveguide has the same advantages as for the waveguides outlined above.

An optical device comprising an optical waveguide as defined above is further provided by the present invention. Examples of devices wherein waveguides according to the invention could be useful are e.g. splitters, couplers, e.g. an arrayed waveguide grating (AWG), a generalized Mach-Zehnder interferometer, and any other functional units being part of an optical communication system. In an embodiment, waveguides according to the invention are included in a duplexer or triplexer. An optical triplexer is an optical component allowing the combination of digital communication and analogue video reception via an optical waveguide. Such a component is e.g. useful in fibre-to-the-home solutions.

In an embodiment, an optical triplexer (or more precisely expressed ‘triplex transceiver component’) gives full-duplex digital communication over a single fiber (1310 nm upstream laser emission and 1490 nm downstream detection) with an additional analogue video receiver (at 1550 nm). The triplex transceiver may be established by hybrid mounting of active devices (laser and photo diodes) on a passive planar light chip established by use of the glass material of the present invention. In a preferred version the triplex transceiver is hybrid mounted by use of a single step solder process for simple interface and support of high volume assembly.

The use of the inventive glass material is advantageous in combination with the triplex transceiver due to the absence of the 1508 nm NH-absorption peak while maintaining the ability to use high index contrast waveguides giving raise to reduced chip size.

It should be emphasized that the term “comprises/comprising” when used in this specification is taken to specify the presence of stated features, integers, steps or components but does not preclude the presence or addition of one or more other stated features, integers, steps, components or groups thereof.

### BRIEF DESCRIPTION OF DRAWINGS

The invention will be explained more fully below in connection with a preferred embodiment and with reference to the drawings in which:

FIG. 1 shows the refractive index at λ=1550 nm for the core region of various optical waveguides according to the invention, before and after annealing, respectively,

FIG. 2 shows corresponding values of layer thickness (closed symbols) and refractive index (open symbols) at λ=1550 nm for the core region of a waveguide according to the invention as a function of annealing temperature,

FIG. 3 shows a measure for the birefringence at λ=1550 nm of a waveguide according to the invention as a function of annealing temperature,

FIG. 4 shows optical absorption loss in dB/cm from λ=1500 nm to λ=1600 nm for a waveguide manufactured according to different processing conditions, respectively, ‘with NH₃’, ‘without NH₃’ and a ‘new process’ according to the invention,

FIG. 5 shows optical propagation loss in dB at λ=1550 nm for a waveguide according to the invention as a function of waveguide length (in cm) and mode (TE or TM),

FIG. 6 shows a cross section of a part of an optical component according to the invention,

FIG. 7a shows an isolated waveguide without neighboring particle formation, and FIG. 7b shows neighboring waveguides with particle formation, and

FIG. 8 shows birefringence vs. refractive index at λ=1550 nm for optical waveguides according to the invention manufactured using different PH₃ flow rates.

The figures are schematic and simplified for clarity, and they just show details which are essential to the understanding of the invention, while other details are left out. Throughout, the same reference numerals are used for identical or corresponding parts.

### MODE(S) FOR CARRYING OUT THE INVENTION

A process according to the invention may be optimized as regards providing a waveguide with a low optical absorption around λ=1508 nm using one or more of the hints listed below:

1. Avoid NH₃ since this is an additional hydrogen source and contains an NH-bond.

2. Lower the SiH₄ flow since this is also a potential hydrogen source.

3. Increase the plasma power since more Si—H bonds will be broken allowing for less incorporation of hydrogen containing Si fragments as compared to when the plasma process is driven at a lower power where it is expected that a smaller amount of Si—H bonds are broken.

4. Increase the total flow since this will flush out the reaction products the most undesirable being hydrogen and hydrogen containing fragments.

5. Increase the temperature since this is expected to decrease the concentration of hydrogen in the plasma grown PECVD glass.

6. Changing the pressure will change the fragmentation degree of the molecules in the plasma and hereby changing the properties of the grown film.

7. Changing the frequency of the energy source driving the plasma will alter the properties of the PECVD grown film.

8. Add a small amount of (optionally diluted) PH₃.

A Combination of one or more of the above mentioned elements may result in a total removal of the N—H peak an overtone of which causes extensive absorption at 1508 nm when a PECVD grown core glass is used as an optical waveguide.

In various embodiments of the present invention, the waveguide materials comprise a number of the following elements Si, O, N, X (‘X’=B, Al, P, S, As, Sb), H, RE-dopants (‘RE’=Ce, Pr, Nd, Pm, Sm, Eu, Gd, Tb, Dy, Ho, Er, Tm, Yb, Lu ), TE-dopants (‘TE’=Al, F, Ge, Ti, B, P) in the stoichiometric composition SiₐOₓN_{y}X_{z}Hᵥ(RE)_{q}(TE)ₚ, where X denotes one or more of the elements ‘X’ for controlling refractive index and/or optical absorption properties and/or thermal expansion properties, RE one or more of the rare-earth elements ‘RE’ for controlling optical gain, and TE one or more of the elements ‘TE’ for controlling thermal expansion.

PECVD also known as Plasma CVD (PCVD) and Low Pressure Chemical Vapour Deposition (LPCVD) are described in further detail in Hiroshi Nishihara, Masamitsu Haruna and Toshiaki Suhara “Optical integrated circuits”, McGraw-Hill Book Company, (1989), and in Chapter 3 in Marc Madou: “Fundamentals of Microfabrication”, ISBN 0-8493-9451-1, which are incorporated herein by reference.

### EXAMPLE 1

A PECVD core glass has been grown on a standard PECVD apparatus (in this case a standard cluster tool CVD process chamber type PECVD-apparatus from STS (Surface Technology Systems plc of Newport, South Wales, UK) is used for the formation of layers on a silicon substrate using the following parameters:

a) SiH₄ flow rate: 20 sccm

b) N₂O flow rate: 100-400 sccm

c) N₂ flow rate: 2000 sccm

d) 5% PH₃ in N2 flow rate: 10 sccm

e) Power: 700 W

f) Pressure: 250 mTorr

g) Temperature: 350° C.

h) Frequency: 380 kHz

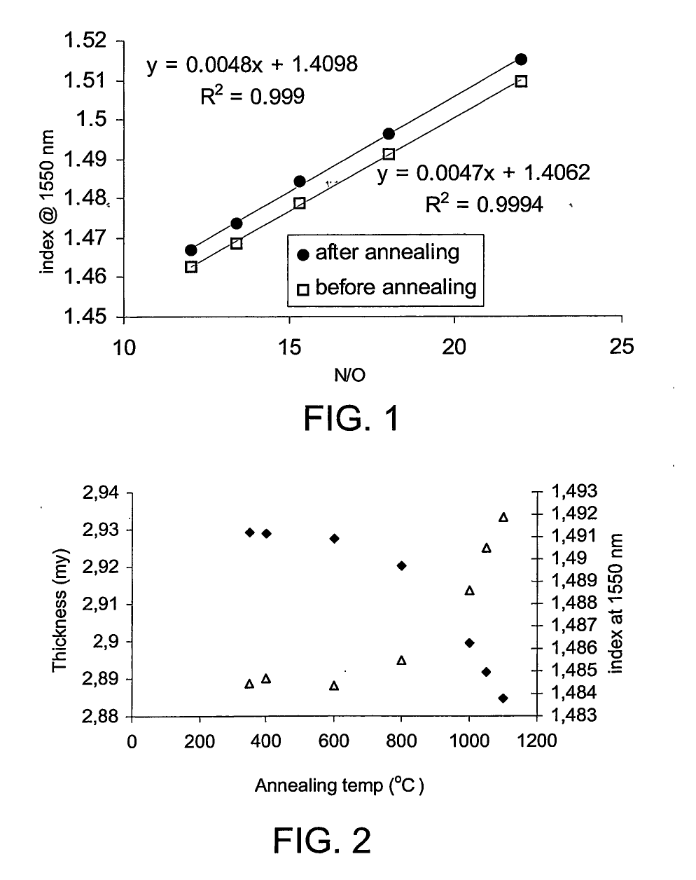

FIG. 1 shows the refractive index at λ=1550 nm for the core region of various optical waveguides according to the invention, before and after annealing, respectively. Annealing was performed at 1100° C. for 4 hours in a nitrogen atmosphere.

The refractive index may easily be tuned in a fairly large range and significantly larger than indicated in FIG. 1. The refractive index change is completely governed by the ratio of nitrogen to oxygen atoms in the PECVD feed gas (at constant SiH₄ flow) as indicated by the linear relation of the refractive index as a function of the [N]/[O] ratio (cf. FIG. 1). Here [N]=2·[N₂O]+2·[N₂]+0.95·5% PH₃/N₂] and [O]=[N₂O] where [xx] denotes the flow rate of species xx in sccm.

FIG. 2 shows corresponding values of layer thickness and refractive index at λ=1550 nm for the core region of a waveguide according to the invention as a function of annealing temperature. Open symbols indicate refractive index at λ=1550 nm. Closed symbols indicate layer thickness in μm. Atomic densities of nitrogen and phosphorus are [N]=1.30·10²¹ atoms/cm³ and [P]=4.58·10²⁰ atoms/cm³, respectively, as determined by calibrated SIMS.

The index of the as deposited PECVD glass can be modified upon annealing as seen in FIG. 2. The index change is initiated above approximately 800° C. and continues beyond 1100° C.

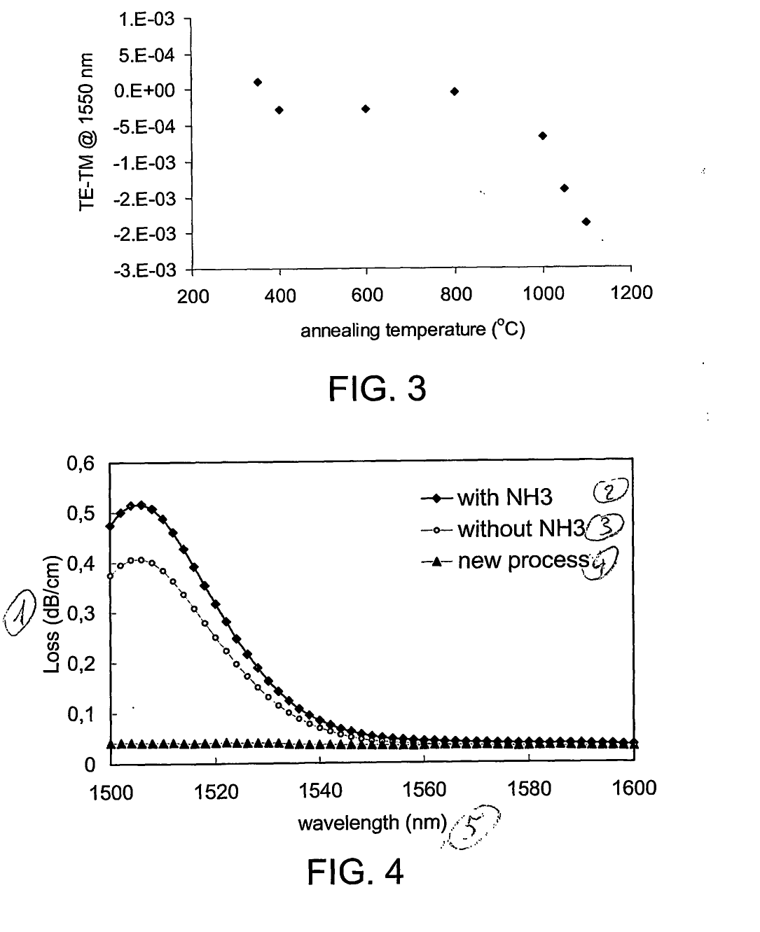

FIG. 3 shows a measure for the birefringence at λ=1550 nm of a waveguide according to the invention as a function of annealing temperature.

The index change is correlated with an increase in the birefringence as seen from FIG. 3 where the difference between refractive index for TE and TM modes measured at λ=1550 nm is plotted as a function of the temperature. Thus, it is suggested to use a relatively low annealing temperature in order to minimize the build up of birefringence. However, the applied annealing temperature should of cause be compatible with subsequent cladding procedure.

An optical component including a waveguide according to the present invention may be manufactured by a method comprising the steps of

A) providing a substrate,

B) forming a lower cladding layer on the substrate,

C1) forming a core layer on the lower cladding layer,

C2) providing a core mask comprising a core region pattern corresponding to the layout of the core regions of optical waveguide elements of the component,

C3) forming core regions using the core mask, a photolithographic and an etching process,

D) forming an upper cladding layer to cover the core region pattern and the lower cladding layer, and

E) annealing in a controlled atmosphere.

The annealing step E) may e.g. be performed after the deposition of the core layer and/or in connection with successive upper deposition and annealing steps.

In an embodiment of the present invention a clean and bare Silicon wafer (used as substrate, step A) is firstly oxidized (step B) to provide an optical isolation layer (the ‘buffer layer’) of silica sufficiently thick that the magnitude of the evanescent field tail of the field pertaining to the waveguide cores is sufficiently low to ensure negligible propagation loss. On top of the buffer layer a layer (termed the ‘core layer’) of SiₐOₓN_{y}X_{z}Hᵥ(RE)_{q}(TE)ₚ (with meaning as described above) is deposited (step C1), containing one or more dopants that effectively act to control the refractive index of the layer, to make it optically active, and/or to adapt its thermal expansion properties to those of the substrate. Depending upon the method used to deposit the core layer a high temperature treatment (known as an anneal step) may be advantageous in order to stabilize the optical and/or mechanical properties of the layer. The optical waveguide circuitry is defined through standard optical lithography where a UV-transparent plate containing typically a chromium pattern replica of the waveguide design pattern (step C2) is pressed against a layer of UV-sensitive polymer which has been spin coated onto the surface of the core layer, subsequently the UV-sensitive polymer is exposed through the mask and the pattern is developed (step C3). Following the exposure and development of the waveguide pattern into the polymer layer, the polymer pattern is used as masking material for dry etching (e.g. RIE—Reactive Ion Etching, ICP—Inductively Coupled Plasma) into the core layer (step C3). In step C2), alternatively, a second mask system can be sandwiched between the core layer and the UV-sensitive polymer layer, which is used to enhance selectivity and waveguide core profile. In an embodiment of the invention this second mask system may consist of oxide/polymer or nitride/polymer such as discussed for oxide polymers by J. M. Moran and D. Maydan: “High resolution, steep profile resist patterns” J. Vac. Sci. Technol., Vol. 16, No 6, November/December 1979 and for nitride polymers by H. Namatsu, Y. Ozaki, and K. Hirata, “high resolution trilevel resist”, J. Vac. Sci. Technol., 21(2), July/August 1982. In this way the design waveguide pattern is transferred into the core layer having predetermined cross-sectional properties as well as refractive index. In order to protect the thus defined waveguide core, and in order to enhance symmetry in the structure transverse to the direction of propagation, a layer of silica with optical properties as close to those of the buffer layer as the chosen fabrication technology permits is deposited on top of the core structure (step D). The formation of the latter layer (e.g. termed the upper cladding layer) may be formed using successive deposition and annealing steps (i.e. successive repetitions of steps D and E). It may be advantageous to ensure that the upper cladding layer has a lower flow temperature than that of the core and lower cladding layers. This may be controlled by proper addition of boron, phosphorus and/or fluorine (or any other dopants that reduces the flow temperature to the upper cladding layer.

A sample with a refractive index contrast of Δn/<n>=2.5% was made according to the above mentioned procedure on top of 12 micron thermal oxide (SiO₂). Spiral waveguides with a cross section of 3×3 micron² was fabricated and subsequently cladded with an optimized cladding procedure (a standard BPSG-cladding). The hereby obtained waveguides were characterized (as described in B. H. Larsen, et al., We1.2.6, ECOC-IOOC, 2003) by direct, and hence, reliable propagation losses after propagation through up to 1 meter of waveguides. These characterization experiments reveal that when applying the parameters listed in EXAMPLE 1, it is possible to remove the overtone of the N—H absorption peak located at 1508 nm as indicated by the curve ‘new process’ in FIG. 4 illustrating optical absorption loss in dB/cm from λ=1500 nm to λ=1600 nm for a waveguide manufactured according to different processing conditions, respectively, ‘with NH3’, ‘without NH3’ and a ‘new process’ according to the invention.

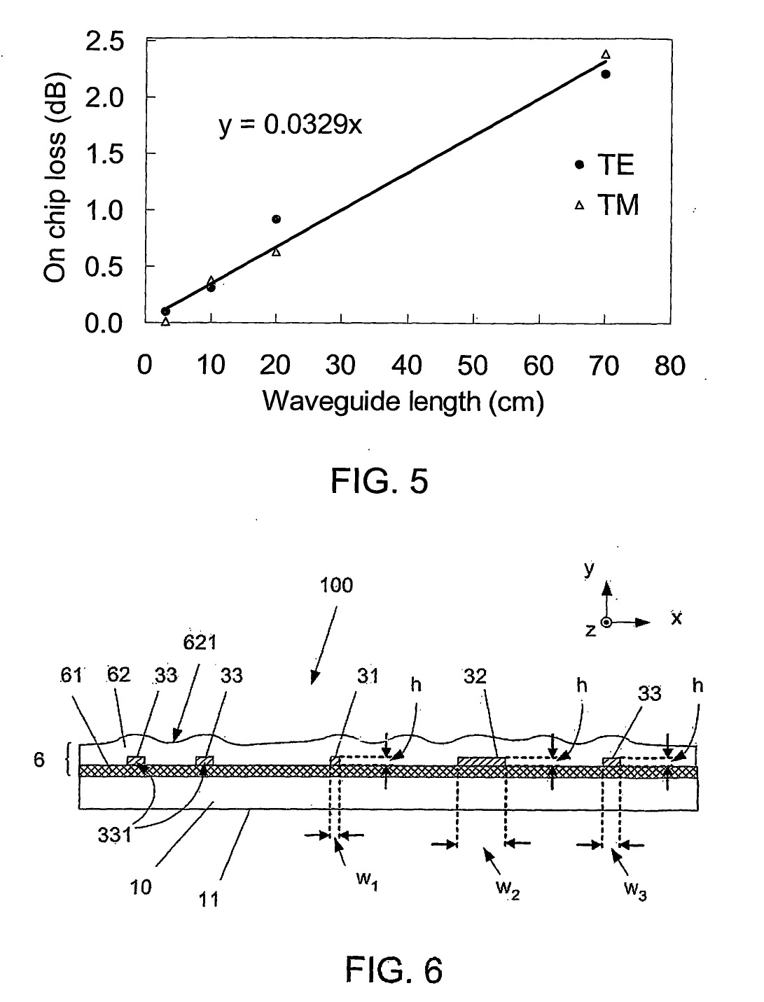

By measuring the propagation loss as a function of the length at 1550 nm we have managed to fabricate waveguides with an extremely low loss below 0.03 dB/cm over a very broad range of wavelengths, as seen in FIG. 5 showing optical propagation loss in dB at λ=1550 nm for a waveguide according to the invention as a function of waveguide length (in cm) and mode (TE or TM).

The sample made by the parameters listed under EXAMPLE 1 has been analyzed by Secondary Ion Mass Spectrometry (SIMS). Briefly the sample under investigation is sputtered by a flux of accelerated ions (here Cs⁺) by which material is continuously being removed from the surface layer. A simple monitoring and on-line analysis of fragments produced by sputtering will allow for chemical analysis as a function of sputtering time. By calibration of sputtering yield and by comparison with relevant references, the intensity of relevant fragments can directly be converted into concentrations (here e.g. N and P are relevant).

For the sample made by the procedure described in EXAMPLE 1 the N and P concentrations were determined to [N]=1.30·10²¹ atoms/cm³ and [P]=4.58·10²⁰ atoms/cm³ corresponding to an [N]/[P] ratio of 2.83.

Assuming a density close to 2.3 g/cm³ as has been reported for SiON-type materials (cf. “Plasma-enhanced growth, composition and refractive index of silicon oxy-nitride films”, K. E. Mattsson, J. Appl. Phys. 77, No. 12, p. 6616-6623, 1995) and a molar weight close to that of SiO₂ (28.086 g/mole+2·15.999 g/mole=60.0840 g/mole) one can convert the measured atomic densities to stoichiometric values since the density of a SiON type material is close to 2.3 g/cm³/60.0840 g/mole=0.0383 mole/cm³. Multiplying with Avogadro's constant Nₐ one obtain an atom density of 2.3052·10²² atoms/cm³.

This leads to the following relative concentrations y and z of nitrogen and phosphorus, respectively:
N_{y}: y=1.30·1021/2.3052·1022=0.056
P_{z}: z=4.58·1020/2.0352·1022=0.020

### EXAMPLE2

A sample comprising an optical waveguide according to the invention was made as described in example 1 with the only difference that the 5% PH₃/95% N₂ gas flow was increased from 10 to 50 sccm. The hereby grown PECVD films delaminated upon annealing due to the high P-content. Thus, there is an upper limited to the amount of PH₃ which can be present under PECVD growth of a core under the above mentioned process parameters.

### EXAMPLE 3

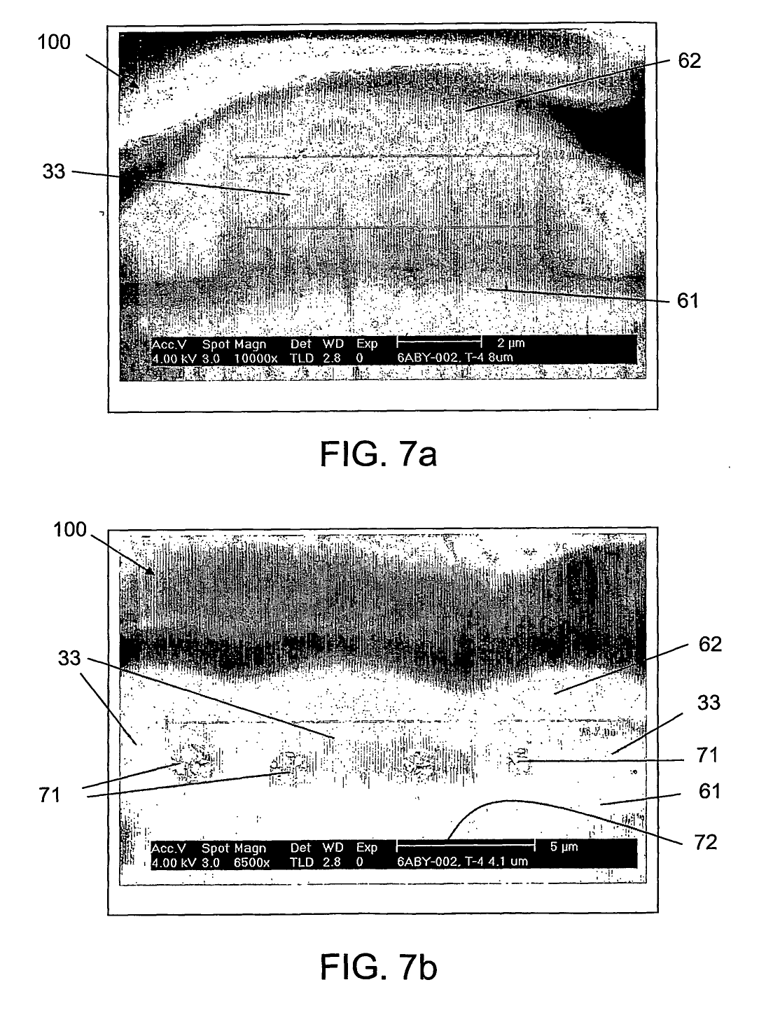

A sample comprising an optical waveguide according to the invention was made as described in example 1. The structure of the resulting waveguides were subsequently analyzed by Scanning Electron Microscopy (SEM) of polished cross sectional cuts. FIG. 7a shows the resulting waveguide profiles for an isolated waveguide 100 comprising core 33, lower 61 and upper 62 cladding regions. From FIG. 7a, it is evident that the waveguide core 33 (having a width of app. 7 μm as indicated in the SEM-photo) is (partially) surrounded by the upper cladding layer 62, and furthermore, no defects can be seen close to the waveguide core region. For closer spaced waveguides (e.g. for edge-to-edge spacings 72 less than 4 μm, cf. FIG. 7b), one observes an apparent reaction between the (upper) cladding layer 62 and the waveguide core material 33 resulting in the nucleation and growth of small crystallites/particles 71 next to the waveguide core regions. FIG. 7b shows a representative SEM image of this particle formation process in-between neighboring waveguide core regions (here having an edge to edge spacing of 5 μm as indicated in the SEM-photo). It has surprisingly turned out that the formation of these crystallites can be prevented by adding a buffer layer between the core region and the upper cladding layer. In the present case a buffer layer of 0.35 μm undoped PECVD SiO₂ on top of the etched core layer was enough to avoid crystallite/particle formation. The appropriate minimum thickness depends on the dopant levels of the core and cladding, respectively (higher dopant levels=>higher thickness). The buffer layer thickness is preferably in the range from 0.2 μm to 1.0 μm. Other buffers/barriers such as PECVD BPSG with alternative B/P doping levels, SiON, SiₓN_{y} (e.g. Si₃N₄), etc. (and correspondingly optimized layer thicknesses) might be applied.

In a preferred embodiment of the method outlined in Example 1, a sub-step “C4) of forming a barrier layer on top of said core region pattern, and optionally on top of the lower cladding layer not covered by the core region pattern;”

is inserted before step D) of forming an upper cladding layer to cover the core region pattern and the lower cladding layer. Optionally, a barrier layer may be applied below the core region pattern by inserting a sub-step C0) of forming a barrier layer on top of said lower cladding layer. The latter has the advantage of fully isolating the core layer from the lower and upper cladding layers. An optional annealing step may be inserted after the barrier layer formation step(s) to relax the barrier layer. An advantage of inserting the buffer layer or layers is that the tendency to formation of crystallites may be lowered or eliminated. Thereby the out-diffusion of Phosphorus from the core region may be lowered or eliminated. It may further have the advantage of reducing stress in the waveguide core. These effects of the inclusion of a barrier layer between the core and cladding regions are particularly advantageous for waveguides according to the present invention for which the concentration (y) of X (including e.g. P) is larger than the concentration (z) of N (i.e. for y/z>1 as defined by the present invention).

It might be tempting to associate the observed particles due to the formation of B₂O₃, P₂O₅ or BPO₄, crystallites. Formation of such particles has been observed as a consequence of Boron and Phosphorus segregation during annealing of BPSG films (see e.g. S. Imai et al., Appl. Phys. Lett. 60(22), p. 1761). Thus, adding the above mentioned buffer will clearly alter the relative concentration of B and P preventing the local nucleation and growth of crystallites.

### EXAMPLE 4

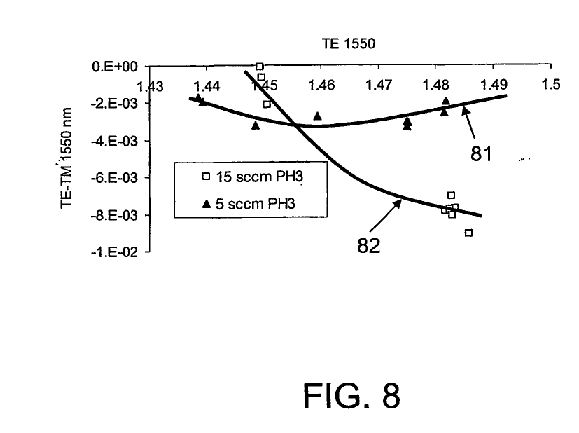

A core made according to Example 1 has been made with two different PH₃ flows. The index was in both cases tuned by adjusting the N₂O flow keeping everything else constant. From FIG. 8, it is evident that it is possible to bridge an index range (measured at 1550 nm) from approximately 1.44 up to 1.5 for both series of PH₃ flows. From the figure it is interesting to note that the birefringence (n(TE)−n(TM)) is lowest for the 5 sccm PH₃ series 81 as compared to the 15 sccm PH₃ series 82. Furthermore, for the 15 sccm series it is observed that the birefringence increases with increasing refractive index whereas it stays approximately constant for the 5 sccm PH₃ series at a lower value of −2·10⁻³ to −3·10⁻³.

Thus the exact PH₃ flow value can be used as an additional stress optimization parameter when tuning the exact core process in connection with further applications of this type of core.

### BASIC ELEMENTS

For waveguides according to the invention comprising material of the composition SiₐOₓN_{y}X_{z}Hᵥ, the individual elements may be introduced—mainly from a vapour phase—from the following compounds:

Silicon, Si:

SiH₄, SiF₄, SiCl₄, SiF₄, Si₂H₆, SiH₂Cl₂, SiCl₂F₂, SiH₂F₂ or any other silicon containing gases or solids involving the use of hydrogen, chlorine, oxygen or even from solid compounds such as SiOx or spin on type glasses as well as sol-gel compounds containing Si.

Oxygen, O:

N₂O, NO, N₂, NO₂, O₂, H₂O; H₂O₂, CO, CO₂

Nitrogen, N:

N₂O, NO, N₂, NO₂, NH₃, N₂

Boron, B:

B₂H₆ or from solid compounds such as B₂O₃

Aluminum, Al:

AlH₃ or liquid solved Organo-Al complexes

Phosphorus, P:

PH₃

Sulfur, S:

H₂S, SO, SO₂

Germanium, Ge:

GeH₄ or solid compounds such as GeO₂

Arsenic, As:

AsH₃

Antimony, Sb:

Sb dissolved in Organo compounds.

Carrier gas selected from:

N₂, He, Ne, Ar, Kr, Xe

### AN EXAMPLE BASED ON ATOMIC CONCENTRATIONS

In the following a correlation is established between relative stoichiometric concentrations (the a, x, y, z, v's in SiₐOₓN_{y}X_{z}Hᵥ) and corresponding atomic densities for various mass densities of the resulting material. This is e.g. of use when a SIMS measurement is made to determine the atomic concentration of a given sample.

The ‘atomic’ concentration (units SiₐOₓN_{y}X_{z}Hᵥ/cm³) in a given volume of a SiₐOₓN_{y}X_{z}Hᵥ type material is calculated as the mass density (ρ(g/cm³)) divided by the mole mass Mₜₒₜ (g/mole) multiplied by Avogadro's number Nₐ. The total mole mass of SiₐOₓN_{y}X_{z}Hᵥ is given by a weighted sum of the mole masses of the constituting elements, i.e. Mₜₒₜ=a·M_{Si}+x·Mₒ+y·M_{N}+z·M_{X}+v·M_{H}.

The individual atom densities Nₐₜ (atoms/cm³) of each type of atom will then be given by:
Nₐₜ(Si)=a/(a+x+y+z+v)·total number of atoms=a·ρ·Nₐ/[(a+x+y+z+v)·Mₜₒₜ]
Nₐₜ(O)=x/(a+x+y+z+v)·total number of atoms=x·ρ·Nₐ/[(a+x+y+z+v)·Mₜₒₜ]
Nₐₜ(N)=y/(a+x+y+z+v)·total number of atoms=y·ρ·Nₐ/[(a+x+y+z+v)·Mₜₒₜ]
Nₐₜ(X)=z/(a+x+y+z+v)·total number of atoms=z·ρ·Nₐ/[(a+x+y+z+v)·Mₜₒₜ]
Nₐₜ(H)=v/(a+x+y+z+v)·total number of atoms=v·ρ·Nₐ/[(a+x+y+z+v)·Mₜₒₜ]

In an embodiment of the invention the above method can be illustrated by assuming a type of structure such as Si_{(1-z)}O_{(2-y)}N_{y}P_{z} wherein P is taken as an example from the group of elements denoted by X in the general formula (‘X’=B, Al, P, S, As, Sb). In this example, P is assumed to substitute Si and N to substitute O. The addition of a small amount of Hᵥ (either intentionally or unintentionally) is not expected to have a major impact on either ρ or Mₜₒₜ due the small size and mass of hydrogen as well as the small concentration of H expected. However, the local presence of H might be important since the material should be valence neutral, i.e. (1−z)·[oxidation state of Si]+(2−y)·[oxidation state of O]+y·[oxidation state of N]+z·[oxidation state of P]+v·[oxidation state of H]=0.

The reported oxidation states are:

H:

+1 and −1 with +1 being the most obvious configuration in connection with covalent hydrides

O:

−2 and −1, with −2 being the most obvious state

Si:

+4, +6, −2, with +4 being the most stable configuration in connection with SiO₂ like materials

N:

+3, −3, +4, +5, with the −3 state being the most stable configuration in the present content

P:

+3, +5, −3, with +5 being the most stable state.

Thus one can write:

(1−z)·(+4)+(2−y)·(−2)+y·(−3)+z·(+5)+v·(+1)=4−4z−4+2y−3y+5z+v=z−y+v=0, i.e. z=y−v, assuming the above mentioned oxidation states of the individual compounds. Thus in this simple model, a small amount of hydrogen will allow for z<y, i.e. for more nitrogen than phosphors. Alternative valance states of the constituents may not be neglected.

Assuming a Si_{(1-z)}O_{(2-y)}N_{y}P_{z} type of material, z will be between 0 and 1 and y will be between 0 and 2. In an embodiment of the invention, z will be between e.g. 0 and 0.2 and y will be between 0 and 0.1 and y>z. The presence of hydrogen is not incorporated in the following calculations although a small amount may be present.

In the above mentioned intervals, Mₜₒₜ has been calculated as:

Mₜₒₜ=(1−z)·M_{Si}+(2−y)·Mₒ+y·M_{N}+z·Mₚ, with

M_{Si}=28.086 g/mole

Mₒ=15.999 g/mole

M_{P}=30.974 g/mole

M_{N}=14.007 g/mole

The result for Mₜₒₜ has been summarized in table 1. As can be seen from table 1, Mₜₒₜ is only varying between 59.69 g/mole and 60.17 g/mole.

TABLE 1
Mole mass (g/mole) for a Si_{(1-z)}O_{(2-y)}N_{y}P_{z}
type material with z ε [0, 0.1], y ε [0, 0.2] and y > z.

| mole mass | | | | | | | | | | | | |
|---|---|---|---|---|---|---|---|---|---|---|---|---|
| (g/mole) | y | | | | | | | | | | | |
| z | 0 | 0.01 | 0.02 | 0.03 | 0.04 | 0.05 | 0.06 | 0.07 | 0.08 | 0.09 | 0.1 | 0.11 |
| 0 | 60.08 | 60.06 | 60.04 | 60.02 | 60.00 | 59.98 | 59.96 | 59.94 | 59.92 | 59.90 | 59.88 | 59.86 |
| 0.01 | | 60.09 | 60.07 | 60.05 | 60.03 | 60.01 | 59.99 | 59.97 | 59.95 | 59.93 | 59.91 | 59.89 |
| 0.02 | | | 60.10 | 60.08 | 60.06 | 60.04 | 60.02 | 60.00 | 59.98 | 59.96 | 59.94 | 59.92 |
| 0.03 | | | | 60.11 | 60.09 | 60.07 | 60.05 | 60.03 | 60.01 | 59.99 | 59.97 | 59.95 |
| 0.04 | | | | | 60.12 | 60.10 | 60.08 | 60.06 | 60.04 | 60.02 | 60.00 | 59.98 |
| 0.05 | | | | | | 60.13 | 60.11 | 60.09 | 60.07 | 60.05 | 60.03 | 60.01 |
| 0.06 | | | | | | | 60.14 | 60.12 | 60.10 | 60.08 | 60.06 | 60.04 |
| 0.07 | | | | | | | | 60.15 | 60.13 | 60.11 | 60.09 | 60.07 |
| 0.08 | | | | | | | | | 60.16 | 60.14 | 60.12 | 60.10 |
| 0.09 | | | | | | | | | | 60.16 | 60.14 | 60.12 |
| 0.1 | | | | | | | | | | | 60.17 | 60.15 |

| mole mass | | | | | | | | | |
|---|---|---|---|---|---|---|---|---|---|
| (g/mole) | y | | | | | | | | |
| z | 0.12 | 0.13 | 0.14 | 0.15 | 0.16 | 0.17 | 0.18 | 0.19 | 0.2 |
| 0 | 59.84 | 59.83 | 59.81 | 59.79 | 59.77 | 59.75 | 59.73 | 59.71 | 59.69 |
| 0.01 | 59.87 | 59.85 | 59.83 | 59.81 | 59.79 | 59.77 | 59.75 | 59.73 | 59.71 |
| 0.02 | 59.90 | 59.88 | 59.86 | 59.84 | 59.82 | 59.80 | 59.78 | 59.76 | 59.74 |
| 0.03 | 59.93 | 59.91 | 59.89 | 59.87 | 59.85 | 59.83 | 59.81 | 59.79 | 59.77 |
| 0.04 | 59.96 | 59.94 | 59.92 | 59.90 | 59.88 | 59.86 | 59.84 | 59.82 | 59.80 |
| 0.05 | 59.99 | 59.97 | 59.95 | 59.93 | 59.91 | 59.89 | 59.87 | 59.85 | 59.83 |
| 0.06 | 60.02 | 60.00 | 59.98 | 59.96 | 59.94 | 59.92 | 59.90 | 59.88 | 59.86 |
| 0.07 | 60.05 | 60.03 | 60.01 | 59.99 | 59.97 | 59.95 | 59.93 | 59.91 | 59.89 |
| 0.08 | 60.08 | 60.06 | 60.04 | 60.02 | 60.00 | 59.98 | 59.96 | 59.94 | 59.92 |
| 0.09 | 60.10 | 60.08 | 60.07 | 60.05 | 60.03 | 80.01 | 59.99 | 59.97 | 59.95 |
| 0.1 | 60.13 | 60.11 | 60.09 | 60.07 | 60.05 | 60.03 | 60.01 | 59.99 | 59.97 |

Applying the above mentioned intervals, it is possible to calculate the atomic densities of Si, O, P and N when knowing the mass density (ρ(g/cm³)) of the material. However, the mass density is expected to vary with the atomic structure. For a PECVD SiON-type material, a density between 2.26 g/cm³ and 2.35 g/mole has been measured (cf. Kent Erik Mattsson, Ph.D thesis MIC, The Technical University of Denmark, 1994). For various forms of quarts, densities such as 2.32, 2.19, 2.26, 2.635, 2.13 g/mole can be found in “Handbook of chemistry and Physics” 66^{TH} edition.

As an illustrative example, the mass density is assumed to be 2.3 g/mole for a Si_{(1-z)}O_{(2-y)}N_{y}P_{z} type material with zε[0, 0.1], yε[0, 0.2] and y>z. The corresponding atomic densities for Si, O, P, and N can be calculated. The resulting values are shown in tables 2, 3, 4, and 5, respectively, wherein 10²¹ is written as 1E21, i.e. e.g. 7.7·10²¹ is written as 7.7E21.

TABLE 2
Atomic density of Si (atoms/cm³) for a Si_{(1-z)}O_{(2-y)}N_{y}P_{z} type material
with z ε [0, 0.1], y ε [0, 0.2] and y > z. The mass density is
assumed to be 2.3 g/mole.

| Density of Si | | | | | | | | | | | | |
|---|---|---|---|---|---|---|---|---|---|---|---|---|
| atoms/cm3 | y | | | | | | | | | | | |
| z | 0 | 0.01 | 0.02 | 0.03 | 0.04 | 0.05 | 0.06 | 0.07 | 0.08 | 0.09 | 0.1 | 0.11 |
| 0 | 7.7E21 | 7.7E21 | 7.7E21 | 7.7E21 | 7.7E21 | 7.7E21 | 7.7E21 | 7.7E21 | 7.7E21 | 7.7E21 | 7.7E21 | 7.7E21 |
| 0.01 | | 7.6E21 | 7.6E21 | 7.6E21 | 7.6E21 | 7.6E21 | 7.6E21 | 7.6E21 | 7.6E21 | 7.6E21 | 7.6E21 | 7.6E21 |
| 0.02 | | | 7.5E21 | 7.5E21 | 7.5E21 | 7.5E21 | 7.5E21 | 7.5E21 | 7.5E21 | 7.5E21 | 7.5E21 | 7.6E21 |
| 0.03 | | | | 7.5E21 | 7.5E21 | 7.5E21 | 7.5E21 | 7.5E21 | 7.5E21 | 7.5E21 | 7.5E21 | 7.5E21 |
| 0.04 | | | | | 7.4E21 | 7.4E21 | 7.4E21 | 7.4E21 | 7.4E21 | 7.4E21 | 7.4E21 | 7.4E21 |
| 0.05 | | | | | | 7.3E21 | 7.3E21 | 7.3E21 | 7.3E21 | 7.3E21 | 7.3E21 | 7.3E21 |
| 0.06 | | | | | | | 7.2E21 | 7.2E21 | 7.2E21 | 7.2E21 | 7.2E21 | 7.2E21 |
| 0.07 | | | | | | | | 7.1E21 | 7.1E21 | 7.1E21 | 7.1E21 | 7.1E21 |
| 0.08 | | | | | | | | | 7.1E21 | 7.1E21 | 7.1E21 | 7.1E21 |
| 0.09 | | | | | | | | | | 7.0E21 | 7.0E21 | 7.0E21 |
| 0.1 | | | | | | | | | | | 6.9E21 | 6.9E21 |

| Density of Si | | | | | | | | | |
|---|---|---|---|---|---|---|---|---|---|
| atoms/cm3 | y | | | | | | | | |
| z | 0.12 | 0.13 | 0.14 | 0.15 | 0.16 | 0.17 | 0.18 | 0.19 | 0.2 |
| 0 | 7.7E21 | 7.7E21 | 7.7E21 | 7.7E21 | 7.7E21 | 7.7E21 | 7.7E21 | 7.7E21 | 7.7E21 |
| 0.01 | 7.6E21 | 7.6E21 | 7.6E21 | 7.6E21 | 7.6E21 | 7.6E21 | 7.6E21 | 7.7E21 | 7.7E21 |
| 0.02 | 7.6E21 | 7.6E21 | 7.6E21 | 7.6E21 | 7.6E21 | 7.6E21 | 7.6E21 | 7.6E21 | 7.6E21 |
| 0.03 | 7.5E21 | 7.5E21 | 7.5E21 | 7.5E21 | 7.5E21 | 7.5E21 | 7.5E21 | 7.5E21 | 7.5E21 |
| 0.04 | 7.4E21 | 7.4E21 | 7.4E21 | 7.4E21 | 7.4E21 | 7.4E21 | 7.4E21 | 7.4E21 | 7.4E21 |
| 0.05 | 7.3E21 | 7.3E21 | 7.3E21 | 7.3E21 | 7.3E21 | 7.3E21 | 7.3E21 | 7.3E21 | 7.3E21 |
| 0.06 | 7.2E21 | 7.2E21 | 7.2E21 | 7.2E21 | 7.2E21 | 7.2E21 | 7.2E21 | 7.2E21 | 7.3E21 |
| 0.07 | 7.2E21 | 7.2E21 | 7.2E21 | 7.2E21 | 7.2E21 | 7.2E21 | 7.2E21 | 7.2E21 | 7.2E21 |
| 0.08 | 7.1E21 | 7.1E21 | 7.1E21 | 7.1E21 | 7.1E21 | 7.1E21 | 7.1E21 | 7.1E21 | 7.1E21 |
| 0.09 | 7.0E21 | 7.0E21 | 7.1E21 | 7.0E21 | 7.0E21 | 7.0E21 | 7.0E21 | 7.0E21 | 7.0E21 |
| 0.1 | 6.9E21 | 6.9E21 | 6.9E21 | 6.9E21 | 6.9E21 | 6.9E21 | 6.9E21 | 6.9E21 | 6.9E21 |

From table 2, it is seen that the density of Si is between 6.9E21 and 7.7E21 atoms/cm³, assuming ρ=2.3 g/cm³.

TABLE 3
Atomic density of N (atoms/cm³) for a Si_{(1-z)}O_{(2-y)}N_{y}P_{z} type
material with z ε [0, 0.1], y ε [0, 0.2] and y > z. The mass density is
assumed to be 2.3 g/mole.

| Density of N | | | | | | | | | | | | |
|---|---|---|---|---|---|---|---|---|---|---|---|---|
| atoms/cm3 | y | | | | | | | | | | | |
| z | 0 | 0.01 | 0.02 | 0.03 | 0.04 | 0.05 | 0.06 | 0.07 | 0.08 | 0.09 | 0.1 | 0.11 |
| 0 | 0.0E+00 | 7.7E19 | 1.5E20 | 2.3E20 | 3.1E20 | 3.8E20 | 4.6E20 | 5.4E20 | 6.2E20 | 6.9E20 | 7.7E20 | 8.5E20 |
| 0.01 | | 7.7E19 | 1.5E20 | 2.3E20 | 3.1E20 | 3.8E20 | 4.6E20 | 5.4E20 | 6.2E20 | 6.9E20 | 7.7E20 | 8.5E20 |
| 0.02 | | | 1.5E20 | 2.3E20 | 3.1E20 | 3.8E20 | 4.6E20 | 5.4E20 | 6.2E20 | 6.9E20 | 7.7E20 | 8.5E20 |
| 0.03 | | | | 2.3E20 | 3.1E20 | 3.8E20 | 4.6E20 | 5.4E20 | 6.2E20 | 6.9E20 | 7.7E20 | 8.5E20 |
| 0.04 | | | | | 3.1E20 | 3.8E20 | 4.6E20 | 5.4E20 | 6.2E20 | 6.9E20 | 7.7E20 | 8.5E20 |
| 0.05 | | | | | | 3.8E20 | 4.6E20 | 5.4E20 | 6.1E20 | 6.9E20 | 7.7E20 | 8.5E20 |
| 0.06 | | | | | | | 4.6E20 | 5.4E20 | 6.1E20 | 6.9E20 | 7.7E20 | 8.5E20 |
| 0.07 | | | | | | | | 5.4E20 | 6.1E20 | 6.9E20 | 7.7E20 | 8.5E20 |
| 0.08 | | | | | | | | | 6.1E20 | 6.9E20 | 7.7E20 | 8.5E20 |
| 0.09 | | | | | | | | | | 6.9E20 | 7.7E20 | 8.4E20 |
| 0.1 | | | | | | | | | | | 7.7E20 | 8.4E20 |

| Density of N | | | | | | | | | |
|---|---|---|---|---|---|---|---|---|---|
| atoms/cm3 | y | | | | | | | | |
| z | 0.12 | 0.13 | 0.14 | 0.15 | 0.16 | 0.17 | 0.18 | 0.19 | 0.2 |
| 0 | 9.3E20 | 1.0E21 | 1.1E21 | 1.2E21 | 1.2E21 | 1.3E21 | 1.4E21 | 1.5E21 | 1.5E21 |
| 0.01 | 9.3E20 | 1.0E21 | 1.1E21 | 1.2E21 | 1.2E21 | 1.3E21 | 1.4E21 | 1.5E21 | 1.5E21 |
| 0.02 | 9.2E20 | 1.0E21 | 1.1E21 | 1.2E21 | 1.2E21 | 1.3E21 | 1.4E21 | 1.5E21 | 1.5E21 |
| 0.03 | 9.2E20 | 1.0E21 | 1.1E21 | 1.2E21 | 1.2E21 | 1.3E21 | 1.4E21 | 1.5E21 | 1.5E21 |
| 0.04 | 9.2E20 | 1.0E21 | 1.1E21 | 1.2E21 | 1.2E21 | 1.3E21 | 1.4E21 | 1.5E21 | 1.5E21 |
| 0.05 | 9.2E20 | 1.0E21 | 1.1E21 | 1.2E21 | 1.2E21 | 1.3E21 | 1.4E21 | 1.5E21 | 1.5E21 |
| 0.06 | 9.2E20 | 1.0E21 | 1.1E21 | 1.2E21 | 1.2E21 | 1.3E21 | 1.4E21 | 1.5E21 | 1.5E21 |
| 0.07 | 9.2E20 | 1.0E21 | 1.1E21 | 1.2E21 | 1.2E21 | 1.3E21 | 1.4E21 | 1.5E21 | 1.5E21 |
| 0.08 | 9.2E20 | 1.0E21 | 1.1E21 | 1.2E21 | 1.2E21 | 1.3E21 | 1.4E21 | 1.5E21 | 1.5E21 |
| 0.09 | 9.2E20 | 1.0E21 | 1.1E21 | 1.2E21 | 1.2E21 | 1.3E21 | 1.4E21 | 1.5E21 | 1.5E21 |
| 0.1 | 9.2E20 | 1.0E21 | 1.1E21 | 1.2E21 | 1.2E21 | 1.3E21 | 1.4E21 | 1.5E21 | 1.5E21 |

From table 3, it is seen that the density of N is between 0 and 1.5E21 atoms/cm³, assuming ρ=2.3 g/cm³.

TABLE 4
Atomic density of P (atoms/cm³) for a Si_{(1-z)}O_{(2-y)}N_{y}P_{z} type material
with z ε [0, 0.1], y ε [0, 0.2] and y > z. The mass density is
assumed to be 2.3 g/mole.

| Density of P | | | | | | | | | | | | |
|---|---|---|---|---|---|---|---|---|---|---|---|---|
| atoms/cm3 | y | | | | | | | | | | | |
| z | 0 | 0.01 | 0.02 | 0.03 | 0.04 | 0.05 | 0.06 | 0.07 | 0.08 | 0.09 | 0.1 | 0.11 |
| 0 | 0.0E00 | 0.0E00 | 0.0E00 | 0.0E00 | 0.0E00 | 0.0E00 | 0.0E00 | 0.0E00 | 0.0E00 | 0.0E00 | 0.0E00 | 0.0E00 |
| 0.01 | | 7.7E19 | 7.7E19 | 7.7E19 | 7.7E19 | 7.7E19 | 7.7E19 | 7.7E19 | 7.7E19 | 7.7E19 | 7.7E19 | 7.7E19 |
| 0.02 | | | 1.5E20 | 1.5E20 | 1.5E20 | 1.5E20 | 1.5E20 | 1.5E20 | 1.5E20 | 1.5E20 | 1.5E20 | 1.5E20 |
| 0.03 | | | | 2.3E20 | 2.3E20 | 2.3E20 | 2.3E20 | 2.3E20 | 2.3E20 | 2.3E20 | 2.3E20 | 2.3E20 |
| 0.04 | | | | | 3.1E20 | 3.1E20 | 3.1E20 | 3.1E20 | 3.1E20 | 3.1E20 | 3.1E20 | 3.1E20 |
| 0.05 | | | | | | 3.8E20 | 3.8E20 | 3.8E20 | 3.8E20 | 3.8E20 | 3.8E20 | 3.8E20 |
| 0.06 | | | | | | | 4.6E20 | 4.6E20 | 4.6E20 | 4.6E20 | 4.6E20 | 4.6E20 |
| 0.07 | | | | | | | | 5.4E20 | 5.4E20 | 5.4E20 | 5.4E20 | 5.4E20 |
| 0.08 | | | | | | | | | 6.1E20 | 6.1E20 | 6.1E20 | 6.1E20 |
| 0.09 | | | | | | | | | | 6.9E20 | 6.9E20 | 6.9E20 |
| 0.1 | | | | | | | | | | | 7.7E20 | 7.7E20 |

| Density of P | | | | | | | | | |
|---|---|---|---|---|---|---|---|---|---|
| atoms/cm3 | y | | | | | | | | |
| z | 0.12 | 0.13 | 0.14 | 0.15 | 0.16 | 0.17 | 0.18 | 0.19 | 0.2 |
| 0 | 0.0E00 | 0.0E00 | 0.0E00 | 0.0E00 | 0.0E00 | 0.0E00 | 0.0E00 | 0.0E00 | 0.0E00 |
| 0.01 | 7.7E19 | 7.7E19 | 7.7E19 | 7.7E19 | 7.7E19 | 7.7E19 | 7.7E19 | 7.7E19 | 7.7E19 |
| 0.02 | 1.5E20 | 1.5E20 | 1.5E20 | 1.5E20 | 1.5E20 | 1.5E20 | 1.5E20 | 1.5E20 | 1.5E20 |
| 0.03 | 2.3E20 | 2.3E20 | 2.3E20 | 2.3E20 | 2.3E20 | 2.3E20 | 2.3E20 | 2.3E20 | 2.3E20 |
| 0.04 | 3.1E20 | 3.1E20 | 3.1E20 | 3.1E20 | 3.1E20 | 3.1E20 | 3.1E20 | 3.1E20 | 3.1E20 |
| 0.05 | 3.8E20 | 3.8E20 | 3.9E20 | 3.9E20 | 3.9E20 | 3.9E20 | 3.9E20 | 3.9E20 | 3.9E20 |
| 0.06 | 4.6E20 | 4.6E20 | 4.6E20 | 4.6E20 | 4.6E20 | 4.6E20 | 4.6E20 | 4.6E20 | 4.6E20 |
| 0.07 | 5.4E20 | 5.4E20 | 5.4E20 | 5.4E20 | 5.4E20 | 5.4E20 | 5.4E20 | 5.4E20 | 5.4E20 |
| 0.08 | 6.1E20 | 6.2E20 | 6.2E20 | 6.2E20 | 6.2E20 | 6.2E20 | 6.2E20 | 6.2E20 | 6.2E20 |
| 0.09 | 6.9E20 | 6.9E20 | 6.9E20 | 6.9E20 | 6.9E20 | 6.9E20 | 6.9E20 | 6.9E20 | 6.9E20 |
| 0.1 | 7.7E20 | 7.7E20 | 7.7E20 | 7.7E20 | 7.7E20 | 7.7E20 | 7.7E20 | 7.7E20 | 7.7E20 |

From table 4, it is seen that the density of P is between 0 and 7.7E20 atoms/cm³, assuming ρ=2.3 g/cm³.

TABLE 5
Atomic density of O (atoms/cm³) for a Si_{(1-z)}O_{(2-y)}N_{y}P_{z} type material
with z ε [0, 0.1], y ε [0, 0.2] and y > z. The mass density is
assumed to be 2.3 g/mole.

| Density of O | | | | | | | | | | | | |
|---|---|---|---|---|---|---|---|---|---|---|---|---|
| atioms/cm3 | y | | | | | | | | | | | |
| z | 0 | 0.01 | 0.02 | 0.03 | 0.04 | 0.05 | 0.06 | 0.07 | 0.08 | 0.09 | 0.1 | 0.11 |
| 0 | 1.5E22 | 1.5E22 | 1.5E22 | 1.5E22 | 1.5E22 | 1.5E22 | 1.5E22 | 1.5E22 | 1.5E22 | 1.5E22 | 1.5E22 | 1.5E22 |
| 0.01 | | 1.5E22 | 1.5E22 | 1.5E22 | 1.5E22 | 1.5E22 | 1.5E22 | 1.5E22 | 1.5E22 | 1.5E22 | 1.5E22 | 1.5E22 |
| 0.02 | | | 1.5E22 | 1.5E22 | 1.5E22 | 1.5E22 | 1.5E22 | 1.5E22 | 1.5E22 | 1.5E22 | 1.5E22 | 1.5E22 |
| 0.03 | | | | 1.5E22 | 1.5E22 | 1.5E22 | 1.5E22 | 1.5E22 | 1.5E22 | 1.5E22 | 1.5E22 | 1.5E22 |
| 0.04 | | | | | 1.5E22 | 1.5E22 | 1.5E22 | 1.5E22 | 1.5E22 | 1.5E22 | 1.5E22 | 1.5E22 |
| 0.05 | | | | | | 1.5E22 | 1.5E22 | 1.5E22 | 1.5E22 | 1.5E22 | 1.5E22 | 1.5E22 |
| 0.06 | | | | | | | 1.5E22 | 1.5E22 | 1.5E22 | 1.5E22 | 1.5E22 | 1.5E22 |
| 0.07 | | | | | | | | 1.5E22 | 1.5E22 | 1.5E22 | 1.5E22 | 1.5E22 |
| 0.08 | | | | | | | | | 1.5E22 | 1.5E22 | 1.5E22 | 1.5E22 |
| 0.09 | | | | | | | | | | 1.5E22 | 1.5E22 | 1.5E22 |
| 0.1 | | | | | | | | | | | 1.5E22 | 1.5E22 |

| Density of O | | | | | | | | | |
|---|---|---|---|---|---|---|---|---|---|
| atioms/cm3 | y | | | | | | | | |
| z | 0.12 | 0.13 | 0.14 | 0.15 | 0.16 | 0.17 | 0.18 | 0.19 | 0.2 |
| 0 | 1.5E22 | 1.4E22 | 1.4E22 | 1.4E22 | 1.4E22 | 1.4E22 | 1.4E22 | 1.4E22 | 1.4E22 |
| 0.01 | 1.4E22 | 1.4E22 | 1.4E22 | 1.4E22 | 1.4E22 | 1.4E22 | 1.4E22 | 1.4E22 | 1.4E22 |
| 0.02 | 1.4E22 | 1.4E22 | 1.4E22 | 1.4E22 | 1.4E22 | 1.4E22 | 1.4E22 | 1.4E22 | 1.4E22 |
| 0.03 | 1.4E22 | 1.4E22 | 1.4E22 | 1.4E22 | 1.4E22 | 1.4E22 | 1.4E22 | 1.4E22 | 1.4E22 |
| 0.04 | 1.4E22 | 1.4E22 | 1.4E22 | 1.4E22 | 1.4E22 | 1.4E22 | 1.4E22 | 1.4E22 | 1.4E22 |
| 0.05 | 1.4E22 | 1.4E22 | 1.4E22 | 1.4E22 | 1.4E22 | 1.4E22 | 1.4E22 | 1.4E22 | 1.4E22 |
| 0.06 | 1.4E22 | 1.4E22 | 1.4E22 | 1.4E22 | 1.4E22 | 1.4E22 | 1.4E22 | 1.4E22 | 1.4E22 |
| 0.07 | 1.4E22 | 1.4E22 | 1.4E22 | 1.4E22 | 1.4E22 | 1.4E22 | 1.4E22 | 1.4E22 | 1.4E22 |
| 0.08 | 1.4E22 | 1.4E22 | 1.4E22 | 1.4E22 | 1.4E22 | 1.4E22 | 1.4E22 | 1.4E22 | 1.4E22 |
| 0.09 | 1.4E22 | 1.4E22 | 1.4E22 | 1.4E22 | 1.4E22 | 1.4E22 | 1.4E22 | 1.4E22 | 1.4E22 |
| 0.1 | 1.4E22 | 1.4E22 | 1.4E22 | 1.4E22 | 1.4E22 | 1.4E22 | 1.4E22 | 1.4E22 | 1.4E22 |

From table 5, it is seen that the density of O is between 1.4E22 and 1.5E22 atoms/cm³, assuming ρ=2.3 g/cm³.

Similar evaluations can be performed for a range of mass densities around 2.3 g/mole. The hereby calculated maximal and minimal atomic densities have been summarized in table 6.

TABLE 6
Mass densities between 1.5 and 4 g/mole and the
hereby maximum and minimum number of atoms per cm³
assuming a Si_{(1-z)}O_{(2-y)}N_{y}P_{z} type material
with z ε [0, 0.1], y ε [0, 0.2] and y > z.

| Massefylde | Si atoms/cm³ | | O atoms/cm³ | | N atoms/cm³ | | P atoms/cm³ | |
|---|---|---|---|---|---|---|---|---|
| g/cm³ | min | maks | min | maks | min | maks | min | maks |
| 1.5 | 4.5E21 | 5.0E21 | 9.0E21 | 1.0E22 | 0.0E00 | 1.0E21 | 0.0E00 | 5.0E20 |
| 1.6 | 4.8E21 | 5.4E21 | 9.6E21 | 1.1E22 | 0.0E00 | 1.1E21 | 0.0E00 | 5.4E20 |
| 1.7 | 5.1E21 | 5.7E21 | 1.0E22 | 1.1E22 | 0.0E00 | 1.1E21 | 0.0E00 | 5.7E20 |
| 1.8 | 5.4E21 | 6.1E21 | 1.1E22 | 1.2E22 | 0.0E00 | 1.2E21 | 0.0E00 | 6.0E20 |
| 1.9 | 5.7E21 | 6.4E21 | 1.1E22 | 1.3E22 | 0.0E00 | 1.3E21 | 0.0E00 | 6.4E20 |
| 2 | 6.9E21 | 7.7E21 | 1.4E22 | 1.5E22 | 0.0E00 | 1.5E21 | 0.0E00 | 7.7E20 |
| 2.1 | 6.3E21 | 7.1E21 | 1.3E22 | 1.4E22 | 0.0E00 | 1.4E21 | 0.0E00 | 7.0E20 |
| 2.2 | 6.6E21 | 7.4E21 | 1.3E22 | 1.5E22 | 0.0E00 | 1.5E21 | 0.0E00 | 7.4E20 |
| 2.3 | 6.9E21 | 7.7E21 | 1.4E22 | 1.5E22 | 0.0E00 | 1.5E21 | 0.0E00 | 7.7E20 |
| 2.4 | 7.2E21 | 8.1E21 | 1.4E22 | 1.6E22 | 0.0E00 | 1.6E21 | 0.0E00 | 8.0E20 |
| 2.5 | 7.5E21 | 8.4E21 | 1.5E22 | 1.7E22 | 0.0E00 | 1.7E21 | 0.0E00 | 8.4E20 |
| 2.6 | 7.8E21 | 8.7E21 | 1.6E22 | 1.7E22 | 0.0E00 | 1.7E21 | 0.0E00 | 8.7E20 |
| 2.7 | 8.1E21 | 9.1E21 | 1.6E22 | 1.8E22 | 0.0E00 | 1.8E21 | 0.0E00 | 9.0E20 |
| 2.8 | 8.4E21 | 9.4E21 | 1.7E22 | 1.9E22 | 0.0E00 | 1.9E21 | 0.0E00 | 9.4E20 |
| 2.9 | 8.7E21 | 9.8E21 | 1.7E22 | 1.9E22 | 0.0E00 | 2.0E21 | 0.0E00 | 9.7E20 |
| 3 | 9.0E21 | 1.0E22 | 1.8E22 | 2.0E22 | 0.0E00 | 2.0E21 | 0.0E00 | 1.0E21 |
| 3.1 | 9.3E21 | 1.0E22 | 1.9E22 | 2.1E22 | 0.0E00 | 2.1E21 | 0.0E00 | 1.0E21 |
| 3.2 | 9.6E21 | 1.1E22 | 1.9E22 | 2.1E22 | 0.0E00 | 2.2E21 | 0.0E00 | 1.1E21 |
| 3.3 | 9.9E21 | 1.1E22 | 2.0E22 | 2.2E22 | 0.0E00 | 2.2E21 | 0.0E00 | 1.1E21 |
| 3.4 | 1.0E22 | 1.1E22 | 2.0E22 | 2.3E22 | 0.0E00 | 2.3E21 | 0.0E00 | 1.1E21 |
| 3.5 | 1.0E22 | 1.2E22 | 2.1E22 | 2.3E22 | 0.0E00 | 2.4E21 | 0.0E00 | 1.2E21 |
| 3.6 | 1.1E22 | 1.2E22 | 2.2E22 | 2.4E22 | 0.0E00 | 2.4E21 | 0.0E00 | 1.2E21 |
| 3.7 | 1.1E22 | 1.2E22 | 2.2E22 | 2.5E22 | 0.0E00 | 2.5E21 | 0.0E00 | 1.2E21 |
| 3.8 | 1.1E22 | 1.3E22 | 2.3E22 | 2.5E22 | 0.0E00 | 2.6E21 | 0.0E00 | 1.3E21 |
| 3.9 | 1.2E22 | 1.3E22 | 2.3E22 | 2.6E22 | 0.0E00 | 2.6E21 | 0.0E00 | 1.3E21 |
| 4 | 1.2E22 | 1.3E22 | 2.4E22 | 2.7E22 | 0.0E00 | 2.7E21 | 0.0E00 | 1.3E21 |

Based on table 6 one can state that for a Si_{(1-z)}O_{(2-y)}N_{y}P_{z} type material with z ε[0, 0.1], yε[0, 0.2] and y>z with a mass density between 1.5 and 4 g/cm³ the atomic densities of Si, O, N and P will be in the ranges indicated below:

The atomic density of Si is between 4.5E21 and 1.3E22 atoms/cm³.

The atomic density of O is between 9.0E21 and 2.7E22 atoms/cm³.

The atomic density of N is between 0 and 2.7E21 atoms/cm³.

The atomic density of P is between 0 and 1.3E21 atoms/cm³.

In an embodiment of the invention (EXAMPLE 1), the density of N and P was determined to [N] =1.30E21 atoms/cm³ and [P] =4.58E20 atoms/cm³ which is within the above mentioned ranges for N and P.

FIG. 6 shows a schematic (x-y-plane) cross sectional view of an optical component 100 according to the invention comprising a base (or lower cladding) layer 61 formed on a substrate 10 with various waveguide core elements 31, 32, 33 applied to the base layer and covered by an upper cladding layer 62 (the combined cladding layers 61, 62 being denoted 6 in FIG. 6). The upper cladding layer has an upper surface 621, possibly being corrugated (although not to scale in FIG. 6) due to an anneal and reflow procedure. Waveguides 31, 32, 33 of different widths w₁, w₂, w₃, respectively, and identical height h (equal to the thickness of the core layer) are shown. The waveguides have end facets 331 (assuming that the cross section of FIG. 6 is an ‘end view’ of a component). The substrate (e.g. a silicon substrate) 10 has a bottom essentially planar face 11 (x-z-plane).

The invention is defined by the features of the independent claim(s). Preferred embodiments are defined in the dependent claims.

Some preferred embodiments have been shown in the foregoing, but it should be stressed that the invention is not limited to these, but may be embodied in other ways within the subject-matter defined in the following claims.

1. An optical waveguide for guiding light in a predefined wavelength range, the optical waveguide comprising core and cladding regions for confining light, the core and/or cladding region or regions being formed on a substrate, and the whole or a part of the core and/or cladding region or regions comprising material of the stoichiometric composition SiₐOₓN_{y}X_{z}Hᵥ, wherein
a is in the range from 0.1 to 3.5;
x is in the range from 0 to 2.5;
y is in the range from 3.9 to 4.1 or in the range from 0.02 to 0.3;
z is in the range from 0 to 0.3 and
X is selected from the group of elements B, Al, P, S, As, Sb and combinations thereof, and the ratio y/z is larger than 1.2, such as larger than 1.5, such as larger than 1.8, such as larger than 2.0, such as larger than 2.5, such as larger than 3.0, such as larger than 3.5, such as larger than 4.0, such as larger than 4.5, such as larger than 5.0, such as larger than 5.5, such as larger than 6.0, such as larger than 7.0, such as larger than 8.0.

2. An optical waveguide according to claim 1 wherein the ratio y/z is in the range from 1.2 to 100, such as 1.2 to 20, such as 1.2 to 10, such as 1.5 to 8.0, such as 2.0 to 4.0, such as 2.5 to 3.5.

3. An optical waveguide according to claim 1 wherein the number a defining the relative concentration of the element Si is in the range from 0.9 to 1.1 or in the range from 2.9 to 3.1.

4. An optical waveguide according to claim 1 wherein the number x defining the relative concentration of the element O is in the range from 1.9 to 2.1 or in the range from 0 to 0.1.

5. An optical waveguide according to claim 1 wherein the number y defining the relative concentration of the element N is in the range from 3.9 to 4.1 or in the range from 0.03 to 0.2, such as in the range from 0.04 to 0.10.

6. An optical waveguide according to claim 1 wherein the number z defining the relative concentration of the element X selected from the group comprising B, Al, P, S, As, Sb and combinations thereof is in the range from 0.005 to 0.2, such as in the range from 0.01 to 0.10.

7. An optical waveguide according to claim 1 wherein a is in the range from 0.8 to 1.2 and x is in the range from 1.8 to 2.2 and y is in the range from 0.01 to 0.5 and z is in the range from 0.005 to 0.2.

8. An optical waveguide according to claim 1 wherein a is in the range from 2.8 to 3.2 and y is in the range from 3.8 to 4.2 and x is in the range from 0.01 to 0.5 and z is in the range from 0.005 to 0.2.

9. An optical waveguide according to claim 1 wherein the number a defining the relative concentration of the element Si is in the range from 0.9 to 1.1, the number x defining the relative concentration of the element O is in the range from 1.9 to 2.1, the number y defining the relative concentration of the element N is in the range from 0.015 to 0.12, and the number z defining the relative concentration of the element X is in the range from 0.005 to 0.04.

10. An optical waveguide according to claim 1 wherein the optical absorption peak at λ=1508 nm due to Si:N—H bonds is smaller than 0.1 dB/cm, such as smaller than 0.05 dB/cm such as smaller than 0.01 dB/cm.

11. An optical waveguide according to claim 1 wherein the number v defining the relative concentration of the element H is such that the relative concentration v/(a+x+y+z+v) of H in SiₐOₓN_{y}X_{z}Hᵥ is smaller than 10⁻², such as smaller than 10⁻³, such as smaller than 10⁻⁴, such as smaller than 10⁻⁵.

12. An optical waveguide according to claim 1 wherein the atomic concentration of hydrogen is larger than the atomic concentration of nitrogen and/or phosphorus.

13. An optical waveguide according to claim 1 wherein the atomic concentration of hydrogen is larger than 5 at. %.

14. An optical waveguide according to claim 1 wherein the number v defining the relative concentration of the element H is such that the concentration v/y of H relative to N is smaller than 10⁻², such as smaller than 10⁻³, such as smaller than 10⁻⁴.

15. An optical waveguide according to claim 1 wherein the number v defining the relative concentration of the element H is such that the concentration v/z of H relative to X is smaller than 10⁻², such as smaller than 10⁻³, such as smaller than 10⁻⁴, X being an element selected from the group comprising B, Al, P, S, As, Sb and combinations thereof.

16. An optical waveguide according to claim 1 wherein the element or elements X or the material SiₐOₓN_{y}X_{z}Hᵥ comprises at least 50% phosphorus such as at least 75% phosphorus such as at least 90% phosphorus, such as 100% phosphorus.

17. An optical waveguide according to claim 1 wherein the element or elements X or the material SiₐOₓN_{y}X_{z}Hᵥ comprises at least two elements X(1), X(2), . . . , X(n) where n≦7, selected from the group comprising B, Al, P, S, Ge, As, Sb of relative concentration z₁, z₂, . . . , zₙ, respectively, where z=z₁+z₂+z₃+ . . . +zₙ and wherein z₁/z is larger than 0.50 such as larger than 0.75 such as larger than 0.90.

18. An optical waveguide according to claim 17 wherein n=2 and X(1) is P and X(2) is B or Ge.

19. An optical waveguide according to claim 17 wherein n=3 and X(1) is P, X(2) is B and X(3) is Ge.

20. An optical waveguide according to claim 1 wherein the waveguide core and/or cladding layers comprise material of the stoichiometric composition Si_{(1-z)}O_{(2-y)}N_{y}X_{z} wherein X is an element form the group comprising B, Al, P, S, As, Sb or a combination thereof.

21. An optical waveguide according to claim 20 wherein X is P.

22. An optical waveguide according to claim 20 wherein 0≦y<0.2 and 0≦z<0.1.

23. An optical waveguide according to claim 1 wherein the atomic density of silicon Nₐₜ(Si) is in the range 4.5·10²¹<Nₐₜ(Si)<1.3·10²², such as in the range 5.1·10²¹<Nₐₜ(Si)<9.1·10²¹, the atomic density of oxygen Nₐₜ(O) is in the range 9.0·10²¹<Nₐₜ(O)<2.7·10²², such as in the range 1.0·10²²<Nₐₜ(O)<1.8·10²², the atomic density of nitrogen Nₐₜ(N) is in the range 0<Nₐₜ(N)<2.7·10²¹, such as in the range 0<Nₐₜ(N)<1.8·10²¹, and the atomic density of phosphorus Nₐₜ(P) is in the range 0<Nₐₜ(P)<1.3·10²¹, such as in the range 0<Nₐₜ(P)<9.0·10²⁰.

24. An optical waveguide according to claim 1 wherein the core and/or cladding region comprises material having a refractive index at a wavelength of 1550 nm in the range 1.45-2.02, such as in the range from 1.45 to 1.60, such as in the range from 1.48 to 1.56.

25. An optical waveguide according to claim 1 wherein the optical waveguide is adapted to guide light in a wavelength range from 250 nm to 3.6 μm, such as in the range from 850 nm to 1800 nm.

26. An optical waveguide according to claim 1 wherein the optical waveguide is adapted to guide light comprising wavelengths in the range from 1260 nm to 1660 nm, such as in the range 1530-1565 nm, or in the range 1460-1530 nm, or in the range 1360-1460 nm, or in the range 1260-1360 nm.

27. An optical waveguide according to claim 1 wherein the waveguide core and/or cladding further comprises a rare earth elements selected from the group of elements comprising Ce, Pr, Nd, Pm, Sm, Eu, Gd, Tb, Dy, Ho, Er, Tm, Yb, Lu or combinations thereof.

28. An optical waveguide according to claim 1 wherein one or more of the rare earth elements are present in molar concentrations in the range from 50 to 5000 ppm mole/mole.

29. An optical waveguide according to claim 1 wherein the core and/or cladding region further comprises one or more TE-dopant elements for controlling the thermal expansion of the waveguide.

30. An optical waveguide according to claim 1 wherein the thermal expansion of one or more of the layers constituting the core and cladding regions of the waveguide is/are adapted to the thermal expansion of the substrate by adding one or more TE-dopant elements to said one or more layers of the waveguide.

31. An optical waveguide according to claim 29 wherein said TE-dopant element or elements are selected from the group of elements comprising Al, F, Ti, or combinations thereof.

32. An optical waveguide according to claim 29 wherein said TE-dopant element or elements are present in the core/and or cladding region or regions in molar concentrations in the range from 0 to 5%.

33. An optical waveguide according to claim 29 wherein said dopant element or elements are present in the core/and or cladding region or regions in amounts sufficient to provide a coefficient of thermal expansion between 1×10⁻⁷ ° C.⁻¹ and 15×10⁻⁷ ° C.⁻¹.

34. An optical waveguide according to claim 1 comprising a buffer material constituting a barrier between the core and cladding regions and fully or partially surrounding said core region.

35. An optical waveguide according to claim 34 wherein said buffer material is selected from the group SiO₂, SiₓN_{y}, such as Si₃N₄, PECVD BPSG with alternative B/P doping levels and combinations thereof.

36. An optical waveguide according to claim 1 wherein said material further comprises Ge.

37. A method of manufacturing an optical waveguide according to claim 1, the method comprising the steps of
A) providing a substrate,
B) forming a lower cladding layer on the substrate,
C) forming a core region of said optical waveguide on the lower cladding layer,
D) forming an upper cladding layer to cover the core region and the lower cladding layer.

38. A method according to claim 37 wherein step
C) comprises the sub-steps
C1) forming a core layer on the lower cladding layer,
C2) providing a core mask comprising a core region pattern corresponding to the layout of the core region of said optical waveguide, and
C3) forming core regions using the core mask, a photolithographic and an etching process.

39. A method according to claim 37 wherein a sub-step
C4) of forming a barrier layer on top of said core region pattern, and optionally on top of the lower cladding layer not covered by the core region pattern;
is inserted before step D)

40. A method according to claim 38 wherein a sub-step C0) of forming a barrier layer on top of said lower cladding layer is inserted before step C1).

41. A method according to claim 39 wherein a sub-step of annealing is inserted after said barrier forming step or steps C0) and/or C4)

42. A method according to claim 37 wherein the substrate is a silicon or quartz substrate.

43. A method according to claim 37 wherein the formation of layers on the substrate is made by plasma enhanced chemical vapour deposition.

44. A method according to claim 43 wherein a standard cluster tool CVD process chamber type PECVD-apparatus from Surface Technology Systems is used for the formation of layers on the substrate.

45. A method according to claim 43 wherein processing parameters of the PECVD-process are optimized with a view to minimizing the optical absorption around λ=1508 nm.

46. A method according to claim 43 wherein processing parameters to be optimized include one or more of the following:
a) SiH₄ flow;
b) the N₂O flow;
c) the N₂ flow;
d) the NH₃ flow;
e) the power;
f) the pressure;
g) the temperature;
h) the frequency;
i) the flow or flows comprising the element or elements X;

47. A method according to claim 43 wherein
a) the SiH₄ flow rate is in the range from 0 to 30 sccm, such as 10 to 30 sccm;
b) the N₂O flow rate is in the range from 0 to 1000 sccm, such as 100 to 400 sccm;
c) the N₂ flow rate is in the range from 0 to 3000 sccm, such as 1000 to 3000 sccm.
d) the NH₃ flow-rate is in the range from 0 to 300 sccm, such as 150 to 250 sccm;
e) the power is in the range from 0 to 1000 W, such as 400 to 1000 W.
f) the pressure is in the range from 100 to 500 mTorr, such as 200 to 500 mTorr.
g) the temperature is in the range from 200 to 500° C., such as 200 to 400° C.
h) the frequency is around 380 kHz or around 13.8 MHz.

48. A method according to claim 46 wherein the X=P and in i) the PH₃ flow is provided by PH₃ diluted in N₂ or another carrier gas.

49. A method according to claim 48 wherein in i) the PH₃ flow is provided by 5% PH₃ in N₂ with a flow rate of 0 to 50 sccm such as 2 to 20 sccm.

50. A method according to claim 46 wherein X comprises P and in i) the PH₃ flow is provided by PH₃ diluted in N₂ or another carrier gas and wherein the PH₃ flow value is used as a stress optimization parameter for the core region.

51. A method according to claim 43 wherein processing parameters of the PECVD process essentially have the following values:
a) SiH₄ flow rate 20 sccm;
b) the N₂O flow rate 100-400 sccm;
c) the N₂ flow rate 2000 sccm;
d) the NH₃ flow rate is 100 sccm;
e) the power is 700 W;
f) the pressure is 250 mTorr;
g) the temperature 350° C.;
h) the frequency is 380 kHz;
i) 5% PH₃ in N₂ flow rate 10 sccm;

52. A method according to claim 46 wherein in step i) the flow gas is selected among the group of gases SiH₄, SiF₄, SiCl₄, SiF₄, Si₂H₆, SiH₂Cl₂, SiCl₂F₂, SiH₂F₂, N₂O, NO, N₂, NO₂, O₂, H₂O, H₂O₂, CO, CO₂, N₂O, NO, N₂, NO₂, NH₃, N₂, B₂H₆, AlH₃, PH₃, H₂S, SO, SO₂, GeH₄, AsH₃, or combinations thereof.

53. An optical device comprising an optical waveguide as defined in claim 1.

54. An optical device according to claim 53 comprising a branching component, such as a splitter or an arrayed waveguide grating.

55. An optical device according to claim 53 comprising an optical duplexer or triplexer.
